(19) United States
(12) Patent Application Publication
(10) Pub. No.: US 2026/0105518 A1
(43) Pub. Date: Apr. 16, 2026

(54) SYSTEMS AND METHODS FOR PERIODIC MATCHING OF ORDERS

(71) Applicant: TRADELOGIQ MARKETS INC., Toronto (CA)

(72) Inventors: Travis Joseph Felker, London (CA); Jonathan Paul Sylvestre, Toronto (CA)

(21) Appl. No.: 19/355,585

(22) Filed: Oct. 10, 2025

Related U.S. Application Data
(60) Provisional application No. 63/706,445, filed on Oct. 11, 2024.

(51) Int. Cl. G06Q 40/04

(52) U.S. Cl. CPC G06Q 40/04

(57) ABSTRACT

Various methods and systems for matching orders are described herein. The methods and systems involve during an order collection phase, receiving from order transmission devices over a network, order packets corresponding to orders including buy order packets corresponding to buy orders and sell order packets corresponding to sell orders, extracting, from the order packets, matching characteristics of the order; and storing the order packets in a memory. During a matching phase subsequent to and separate from the order collection phase, the methods and systems involve retrieving the order packets from the memory and in response to determining at least a subset of the buy orders and the sell orders are compatible, matching the buy orders and the sell orders according to their characteristics. The duration of the order collection phase is less than or equal to ten milliseconds in some embodiments or less than or equal to 100 milliseconds in some other embodiments.

### CROSS-REFERENCE TO RELATED APPLICATIONS

This application claims priority from U.S. provisional application No. 63/706,445, filed Oct. 11, 2024, the contents of which are hereby incorporated herein by reference.

### FIELD

The embodiments described herein generally relate to systems and methods for matching orders for buying and selling securities and other financial instruments and in particular, to periodic matching of orders to buy and sell securities and other financial instruments.

### BACKGROUND

The following is not an admission that anything discussed below is part of the prior art or part of the common general knowledge of a person skilled in the art.

Existing trading systems typically seek to match orders and execute trades immediately upon receipt of each order, and on a continuous basis. In existing trading systems, devices transmitting orders operating over faster networks can sometimes take advantage of changes in market prices, or can engage in price arbitration to the detriment of devices operating over slower networks. In some cases, devices operating over faster networks may be able to amend or cancel an order before it is executed, to the disadvantage of devices operating over slower networks.

Speedbump trading systems have been developed to reduce the impact of unfair advantages caused by discrepancies in network latency or processing resources. Speedbump trading systems generally operate by imposing a delay on all or a subset of orders based on characteristics of the order or a type of user associated with the order to equalize trading opportunities. However, speedbump trading systems are, in most cases, complex and require categorization of orders and evaluation of each individual order to determine whether its characteristics or the type of user with which it is associated require the imposition of a delay in addition to requiring the determination of the length of the delay. Speedbump trading systems may also be inflexible, since they often do not allow for orders to be amended or canceled while held in the speedbump due in part to the additional processing complexity and resources needed to manage order cancellation and modifications to orders held in a speedbump. Speedbump trading systems, by imposing a delay on orders, can also create inefficiencies for the management and execution of orders that are delayed by the system when delayed orders miss opportunities to trade against orders already received by the trading system.

### SUMMARY

This summary is intended to introduce the reader to the more detailed description that follows and not to limit or define any claimed or as yet unclaimed invention. One or more inventions may reside in any combination or sub-combination of the elements or process steps disclosed in any part of this document including its claims and figures.

In a first aspect, in at least one embodiment, there is provided a method of matching orders. The method involves: during an order collection phase: receiving from a plurality of order transmission devices over a network, a plurality of order packets corresponding to orders, the plurality of order packets comprising buy order packets corresponding to buy orders and sell order packets corresponding to sell orders; extracting, from each of the plurality of order packets, one or more matching characteristics of the order; and storing the plurality of order packets in a memory; and during a matching phase subsequent to and separate from the order collection phase: retrieving the plurality of order packets from the memory and in response to determining at least a subset of the buy orders and the sell orders are compatible, matching at least the subset of the buy orders and the sell orders according to the one or more characteristics of the buy orders and sell orders. In some embodiments, the duration of the order collection phase is less than or equal to ten milliseconds. In some other embodiments, the duration of the order collection phase is less than or equal to 100 milliseconds.

In at least one embodiment, during the order collection phase, the method involves initializing a state parameter of each of the order packets; and during the matching phase, modifying the state parameter of at least a subset of the order packets to an executable state, and the at least subset of the buy orders and the sell orders correspond to the at least subset of the order packets having the executable state.

In at least one embodiment, each order packet comprises an order type and/or a time limitation and the matching is based at least in part on the order type and/or the time limitation.

In at least one embodiment, the time limitation is one of: a first time limitation corresponding to orders expiring at an end of the matching phase and a second time limitation corresponding to orders expiring at an end of a trading day or a subsequent trading day, the matching phase includes a first stage and a second stage occurring immediately after the first stage, and the method comprises: during the first stage, matching orders having the first time limitation with orders having the second time limitation; during the second stage, matching orders unmatched during the first stage and having the first time limitation with each other.

In at least one embodiment, the order matching characteristics include one or more: a dealer identifier, an order of reception of the order, a price of the order, a quantity of the order, and a priority type of the order.

In at least one embodiment, the method involves subsequent to the matching phase, storing the order packets corresponding to unmatched buy orders and sell orders expiring at an end of a trading day in the memory.

In at least one embodiment, the method involves processing the plurality of order packets to determine an order of reception of the plurality of order packets and the matching is based in part on the order of reception.

In at least one embodiment, the order of reception is determined based on one of a sequence number and a timestamp associated with each order packet.

In at least one embodiment, the method involves: during the order collection phase, receiving an order modification packet, the order modification packet comprising an order identifier of a buy order packet or sell order packet; and modifying the identified buy order packet or sell order packet.

In at least one embodiment, the order modification packet is an order cancellation packet cancelling the buy order of the identified buy order packet or the sell order of the identified sell order packet.

In at least one embodiment, the method involves: in response to receiving an order packet or an order modification packet during the matching phase, storing the received order packet or the order modification packet in a second memory.

In at least one embodiment, matching at least the subset of the buy orders and the sell orders involves retrieving the order corresponding to the earliest received order packet; identifying one or more candidate matches for the order according to the characteristics; matching the order with one or more of the one or more candidate matches.

In at least one embodiment, a subset of the plurality of order packets correspond to primary peg orders with a non-display portion that includes a minimum interaction size instruction, and wherein the method comprises matching at least the subset of the buy orders and the sell orders according to the minimum interaction size instruction.

In accordance with another aspect, in at least one embodiment, there is provided a system for matching orders. The system includes at least one processor configured to: during an order collection phase: receive from a plurality of order transmission devices over a network, a plurality of order packets corresponding to orders, the plurality of order packets comprising buy order packets corresponding to buy orders and sell order packets corresponding to sell orders; extract, from each of the plurality of order packets, one or more matching characteristics of the order; and store the plurality of order packets in a memory; and during a matching phase subsequent to and separate from the order collection phase: retrieve the plurality of order packets from the memory and in response to determining at least a subset of the buy orders and the sell orders are compatible, match at least the subset of the buy orders and the sell orders according to the one or more characteristics of the buy orders and sell orders. In some embodiments, the duration of the order collection phase is less than or equal to ten milliseconds. In some other embodiments, the duration of the order collection phase is less than or equal to 100 milliseconds.

In at least one embodiment, the at least one processor is configured to: during the order collection phase, initialize a state parameter of each of the order packets; and during the matching phase, modify the state parameter of at least a subset of the order packets to an executable state, and the at least subset of the buy orders and the sell orders correspond to the at least subset of the order packets having the executable state.

In at least one embodiment, each order packet comprises an order type and/or a time limitation and wherein the matching is based at least in part on the order type and/or the time limitation.

In at least one embodiment, the time limitation is one of a first time limitation corresponding to orders expiring at an end of the matching phase and a second time limitation corresponding to orders expiring at an end of a trading day or a subsequent trading day, the matching phase includes a first stage and a second stage occurring immediately after the first stage, and the least one processor is configured to: during the first stage, match orders having the first time limitation with orders of having the second time limitation; during the second stage, match orders unmatched during the first stage and having the first time limitation with each other.

In at least one embodiment, the order matching characteristics include one or more: a dealer identifier, an order of reception of the order, a price of the order, a quantity of the order, and a priority type of the order.

In at least one embodiment, the at least one processor is configured to: subsequent to the matching phase, store the order packets corresponding to unmatched buy orders and sell orders expiring at an end of a trading day or a subsequent trading day in the memory.

In at least one embodiment, the at least one processor is configured to: process the plurality of order packets to determine an order of reception of the plurality of order packets and wherein the matching is based in part on the order of reception.

In at least one embodiment, the order of reception is determined based on one of a sequence number and a timestamp associated with each order packet.

In at least one embodiment, the at least one processor is configured to: during the order collection phase, receive an order modification packet, the order modification packet comprising an order identifier of a buy order packet or sell order packet; and modify the identified buy order packet or sell order packet.

In at least one embodiment, the order modification packet is an order cancellation packet cancelling the buy order of the identified buy order packet or the sell order of the identified sell order packet.

In at least one embodiment, the at least one processor is configured to: in response to receiving an order packet or an order modification packet during the matching phase, store the received order packet or the order modification packet in a second memory.

In at least one embodiment, the at least one processor is configured to: retrieve the order corresponding to the earliest received order packet; identify one or more candidate matches for the order according to the characteristics; match the order with one or more of the one or more candidate matches.

In at least one embodiment, a subset of the plurality of order packets correspond to primary peg orders with a non-display portion that includes a minimum interaction size instruction, and the at least one processor is configured to match at least the subset of the buy orders and the sell orders according to the minimum interaction size instruction.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment, and in which:

FIG. 1 is a block diagram of an example order matching system in communication with external components in accordance with an embodiment;

FIG. 2A is a block diagram of an example order matching system, in accordance with an embodiment;

FIG. 2B is a block diagram of an example order matching system, in accordance with another embodiment;

FIG. 2C is a block diagram of an example order matching system, in accordance with another embodiment;

FIG. 2D is a block diagram of an example order matching system, in accordance with another embodiment;

FIG. 2E is a block diagram of an example order matching system, in accordance with another embodiment;

FIG. 3 is a flowchart of an example method for matching orders, in accordance with an embodiment;

FIG. 4 is a timeline showing order collection phases and matching phases;

FIG. 5A is an example order packet, in accordance with an embodiment;

FIG. 5B is an example order packet, in accordance with another embodiment;

FIG. 6A is a table showing example orders at the start of a matching phase;

FIG. 6B is a table showing the orders of FIG. 6A during the matching phase;

FIG. 6C is a table showing the orders of FIG. 6A at the conclusion of the matching phase;

FIG. 7A is a table showing example orders at the start of a matching phase;

FIG. 7B is a table showing the orders of FIG. 7A at the conclusion of the matching phase;

FIG. 8 is a table showing pricing information for example orders;

FIG. 9 is a table showing pricing information for example orders;

FIG. 10A is a table showing pricing information for example orders, at a first time;

FIG. 10B is a table showing updated pricing information for the example orders of FIG. 10A, at a second time;

FIG. 10C is a table showing updated pricing information for the example orders of FIG. 10A, at a third time;

FIG. 10D is a table showing updated pricing information for the example orders of FIG. 10A, at a fourth time;

FIG. 11A is a table showing pricing information for example orders, at a first time;

FIG. 11B is a table showing updated pricing information for the example orders of FIG. 11A, at a second time;

FIG. 11C is a table showing updated pricing information for the example orders of FIG. 11A, at a third time;

FIG. 12A is a table showing example buy orders at the start of a collection phase;

FIG. 12B is a table showing example sell orders at the start of a collection phase;

FIG. 12C is a table showing example sell orders during the collection phase;

FIG. 12D is a table showing example buy orders during the collection phase immediately prior to the matching phase; and

FIG. 12E is a table showing example sell orders during the collection phase, immediately prior to the matching phase.

The skilled person in the art will understand that the drawings, described below, are for illustration purposes only. The drawings are not intended to limit the scope of the applicant's teachings in any way. Also, it will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DESCRIPTION OF VARIOUS EMBODIMENTS

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

It should be noted that terms of degree such as “substantially”, “about” and “approximately” when used herein mean a reasonable amount of deviation of the modified term such that the end result is not significantly changed. These terms of degree should be construed as including a deviation of the modified term if this deviation would not negate the meaning of the term it modifies.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

The terms “an embodiment,” “embodiment,” “embodiments,” “the embodiment,” “the embodiments,” “one or more embodiments,” “some embodiments,” and “one embodiment” mean “one or more (but not all) embodiments of the present invention(s),” unless expressly specified otherwise.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example and without limitation, the programmable computers may be a server, network appliance, embedded device, computer expansion module, a personal computer, laptop, personal data assistant, cellular telephone, smart-phone device, tablet computer, a wireless device or any other computing device capable of being configured to carry out the methods described herein.

Program code may be applied to input data to perform the functions described herein and to generate output information. The output information is applied to one or more output devices, in known fashion.

Each program may be implemented in a high-level procedural or object oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g. ROM, magnetic disk, optical disc) readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or download, magnetic and electronic storage media, digital and analog signals, and the like. The computer useable instructions may also be in various forms, including compiled and non-compiled code.

Existing trading systems typically seek to match orders and execute trades immediately upon receipt of each order, and on a continuous basis. Since different network devices can have different processing capabilities and access different network resources, certain devices may be at a disadvantage compared to others when transmitting orders. For example, network devices transmitting orders over very fast networks can more quickly take advantage of differences in prices across different markets (e.g., price arbitrage) or of changes in prices within a given market. Network devices that transmit orders over slower networks on the other hand, may not be able to take advantages of these price differences and in some cases, may not be able to cancel or amend orders in time before a disadvantageous trade is executed.

To address these issues, speedbump trading systems have been developed. Speedbump trading systems generally impose a delay on all or a subset of orders based on a characteristic of the order and/or a type of user associated with the order to equalize trading opportunities. However, orders that are held in a delay mechanism often cannot be amended or canceled for reasons that can include the additional processing complexity and resources needed to manage order cancellation and modifications to orders held in a speedbump. Speedbump trading systems are also associated with increased computational resources, since each order must be assessed separately and categorized to determine whether to impose a delay and to determine the length of the delay.

The described embodiments match orders during scheduled, non-continuous matching phases, during which orders collected during a collection phase preceding the matching phase can be matched according to a priority schedule. The matching can be referred to as “periodic matching”. The described embodiments can collect orders during a collection phase and only execute the orders during a separate matching phase. Scheduled matching phases and collection phases can allow orders to be amended or cancelled prior to being matched, allowing network devices to respond to price changes and avoid unwanted matches regardless of the computational resources and network resources associated with the network devices. The described embodiments accordingly enable network devices transmitting orders over various networks and having different computational resources to be processed in substantially the same manner by an order matching system, reducing discrepancies caused by varying network resources and computational resources, without needing to categorize the network devices. By aggregating orders during each collection phase, the described embodiments can additionally allow for more opportunities for two orders to be matched that might not otherwise have matched if each had attempted to trade upon receipt as is the case in systems that match and trade orders on a continuous basis. The embodiments described herein can also avoid expending processing resources used by speedbump trading systems to categorize the orders according to the network devices from which they originate. In addition, the embodiments described herein can optimize utilization of processing resources in the event that several orders are received in a short time period, by avoiding individual delays across each order in favor of a single delay applying to multiple orders simultaneously.

At least some of the embodiments described herein match orders using a two-stage matching process, enabling more than one opportunity for an order to be matched by providing some orders (e.g., orders of a particular type) that remain unfilled after the first stage a second opportunity to be matched. Relative to a speedbump trading system whereby a delayed order upon release from a speedbump is not filled (and cancelled) because the order(s) it sought to trade against when the delayed order was submitted had been cancelled or had been filled by other orders ahead of the delayed order in the speedbump, the described embodiments allow more orders to be filled and allow orders that would otherwise be cancelled when unfilled to be filled.

At least some of the embodiments described herein allow orders to be repriced during periods where the likelihood of receiving an undesirable execution is high.

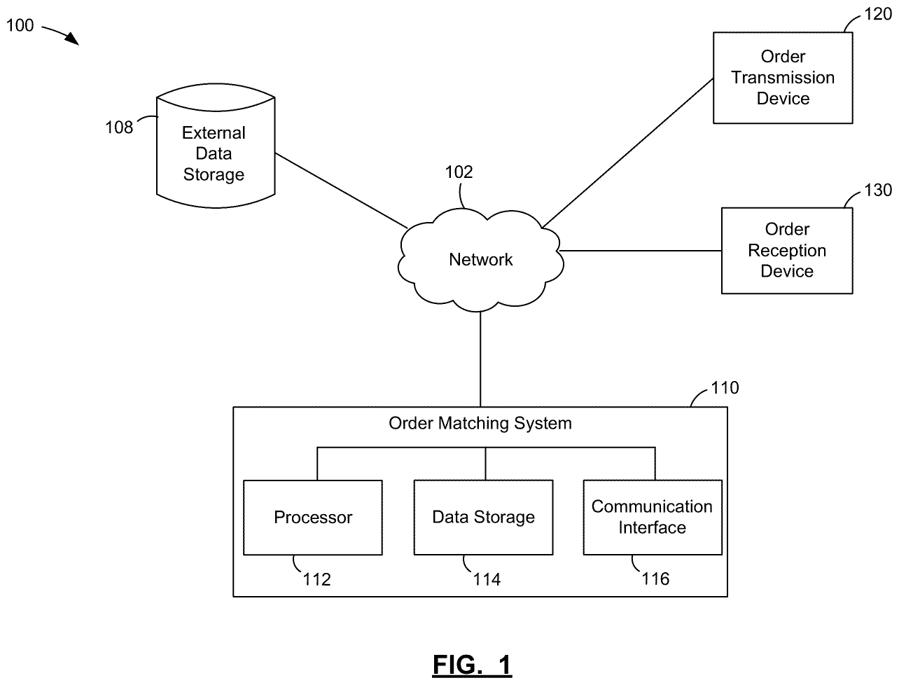

Reference is first made to FIG. 1, which illustrates an example block diagram 100 of an order matching system 110 in communication with an external data storage 108, an order transmission device 120 and an order reception device 130 via a network 102. Although only one order transmission device 120 and only one order reception device 130 are shown in FIG. 1, the order matching system 110 may be in communication with a greater number of order transmission devices 120 and order reception devices 130. The order matching system 110 can communicate with the order transmission devices 120 and order reception devices 130 over a wide geographic area via the network 102. While the order transmission devices 120 and the order reception devices 130 are shown as separate components, in some cases, the order transmission devices 120 and the order reception devices 130 can be the same devices.

The order matching system 110 includes a processor 112, a data storage 114 and a communication component 116. The order matching system 110 can be implemented with more than one computer server distributed over a wide geographic area and connected via the network 102. The processor 112, data storage 114 and communication component 116 may be combined into a fewer number of components or may be separated into further components. The order matching system 110 is a system that receives order packets comprising orders and that matches orders. In at least one embodiment, the order matching system 110 is a cloud-based system.

The processor 112 can be implemented with any suitable processor, controller, digital signal processor, graphics processing unit, application specific integrated circuits (ASICs), and/or field programmable gate arrays (FPGAs) that can provide sufficient processing power for the configuration, purposes and requirements of the order matching system 110. The processor 112 can include more than one processor with each processor being configured to perform different dedicated tasks.

The processor 112 can be configured to control the operation of the order matching system 110. For example, the processor 112 can receive order packets and match the orders comprised in the order packets.

The communication component 116 can include any interface that enables the order matching system 110 to communicate with various devices and other systems. For example, the communication component 116 can receive inputs (e.g., order packets) from the order transmission device 120 and store the order packets in the data storage 114 or external data storage 108. The processor 112 can then process the order packets (e.g., match the orders comprised in the order packets) according to the methods described herein and transmit outputs (e.g. order packets, matched orders, an indication that an order has been matched) to the order reception device 130.

The communication component 116 can include at least one of a serial port, a parallel port or a USB port, in some embodiments. The communication component 116 may also include an interface to component via one or more of an Internet, Local Area Network (LAN), Ethernet, Firewire, modem, fiber, or digital subscriber line connection. Various combinations of these elements may be incorporated within the communication component 116.

The data storage 114 can include RAM, ROM, one or more hard drives, one or more flash drives or some other suitable data storage elements such as disk drives. The storage component 114 can include one or more databases for storing order packets received, matched orders and rules for matching orders. The storage component 114 can store information about order transmission devices and users of the order matching system 110 (e.g., dealers, their trader employees and clients, trading access technology vendors, and others permissioned to transmit orders to the order matching system 110).

The external data storage 108 can store data similar to that of the storage component 114. In some embodiments, the external data storage 108 can be a third-party data storage stored with input data for analysis by the order matching system 110. The data stored in the external data storage 108 can be retrieved by the order matching system 110 via the network 102.

The order transmission device 120 can include any network device capable of communicating with other devices through a network such as the network 102 to transmit orders. The order transmission device 120 can include a processor and memory, and may be an electronic tablet device, a personal computer, workstation, server, portable computer, mobile device, personal digital assistant, laptop, smart phone, WAP phone, an interactive television, video display terminals, gaming consoles, and portable electronic devices or any combination of these. The order transmission device 120 can be associated with a user of the order matching system 110.

The order reception device 130 can include any network device capable of communicating with other devices through a network such as the network 102 to receive filled orders. The order reception device 130 can include a processor and memory, and may be an electronic tablet device, a personal computer, workstation, server, portable computer, mobile device, personal digital assistant, laptop, smart phone, WAP phone, an interactive television, video display terminals, gaming consoles, and portable electronic devices or any combination of these. As explained, in some cases, the order transmission device 120 and the order reception device 130 can be implemented on the same device. For example, the device can act as the order transmission device 120 when transmitting an order packet (e.g., a buy order packet, a sell order packet) and act as the order reception device 130 when the order transmitted is matched by the order matching system 110. The order reception device 130 can be associated with a user.

The network 102 can include any network capable of carrying data, including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these, capable of interfacing with, and enabling communication between, the order matching system 110, the external data storage 108, and the order transmission device 120 and the order reception device 130.

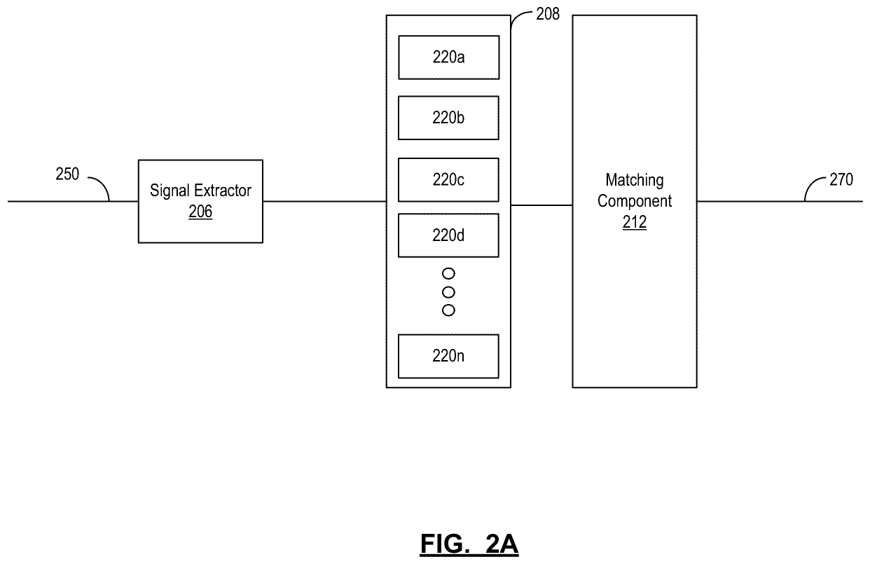

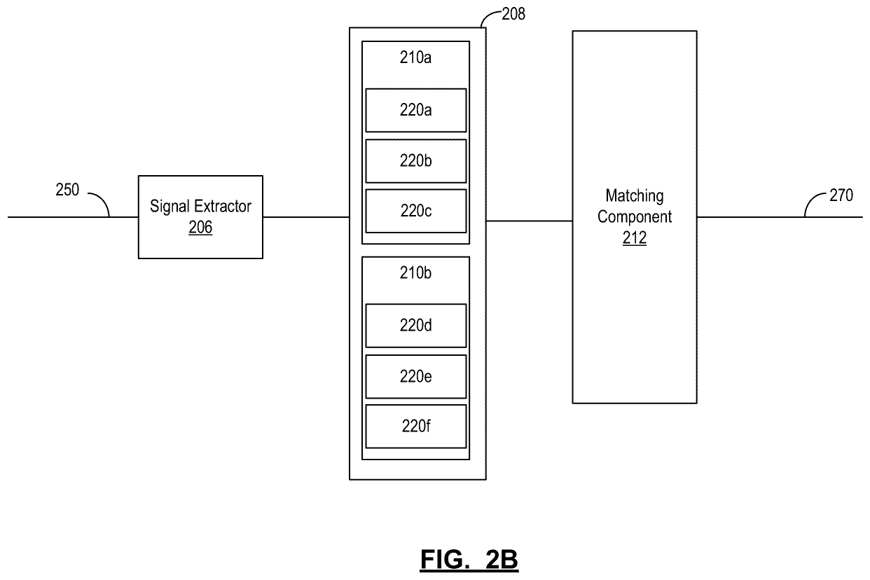

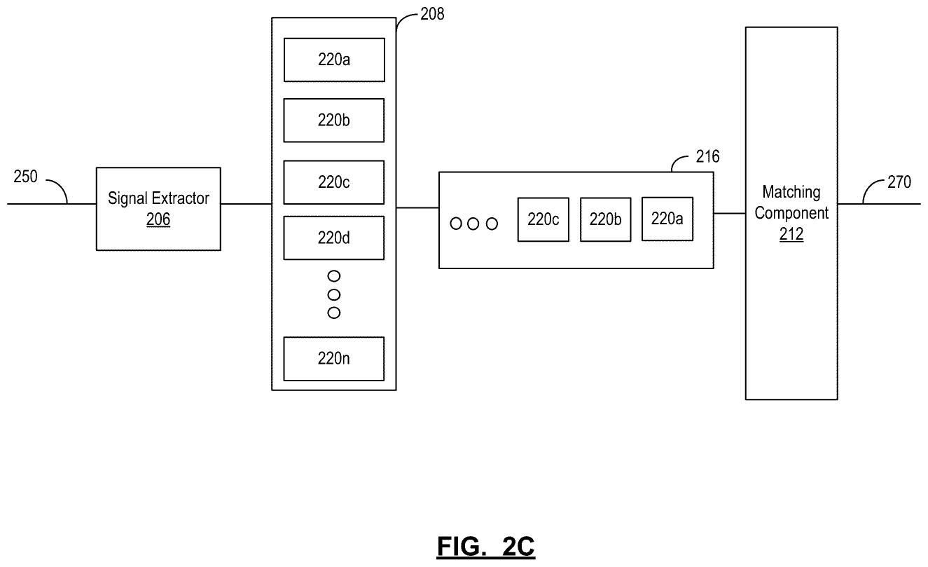

Reference is now simultaneously made to FIGS. 2A-2E, which show block diagrams of components of an example order matching system, such as the order matching system 110. As shown, the order matching system includes a signal extractor 206 that can receive an order signal that can include order packets and extract the order packets and/or information (e.g., a type of order, an order side, an order identifier, a device identifier, a quantity, a price) from the order packets. Alternatively, the order packets can be received as packets and the signal extractor 206 can extract information about the order packets. The order matching system 110 also includes one or more data stores 208 that can store order packets 220; a matching component 212 that can match order packets 220 stored in the data stores 208 and transmit the matched orders via an output order matching signal 270. The output order matching signal can include an indication that one or more orders have been matched and the orders that have been matched and/or can be a signal transmitted to the order reception device 130 indicating the fulfillment of an order. The data stores 208 can be implemented by the data storage 114.

The data store 208 can include one or more memory buffers that can store received order packets that have not yet been matched. The components shown in FIGS. 2A-2E can be associated with one or more types of financial instruments. For example, each type of financial instrument can be associated with a signal extractor 206, one or more data stores 208 and a matching component 212. Alternatively, the signal extractor 206 can extract from the order packets a type of financial instrument and the order packet can be stored in a data stored 208 dedicated to the determined type of financial instrument. Similarly, the order matching system 110 can include a matching component 212 dedicated to each type of financial instrument and in some cases, to each order type as will be explained in further detail below or can include one or more matching components 212 that can process different types of financial instruments.

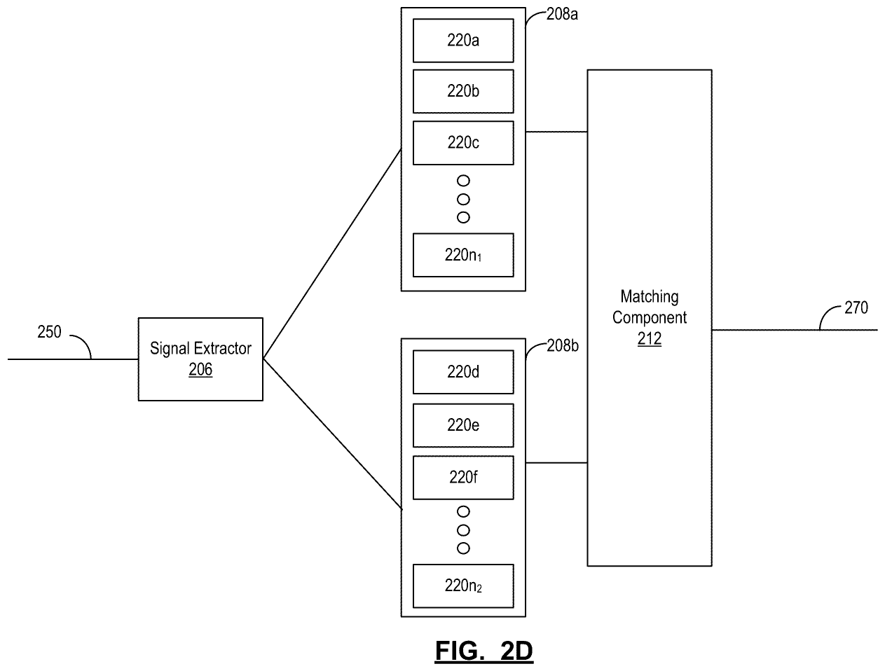

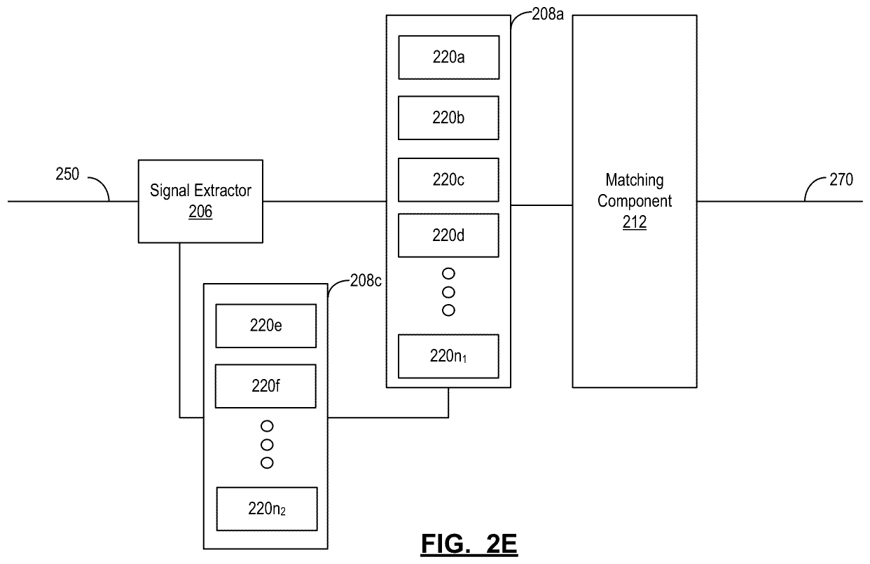

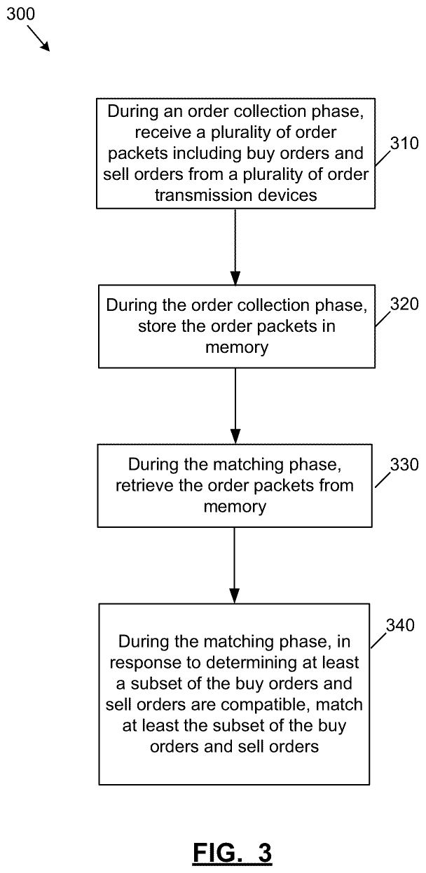

Reference is now made to FIG. 3, which shows a flowchart 300 of an example method of matching orders according to an embodiment. The method 300 can be implemented by a processor of the order matching system 110, for example, the processor 112.

At 310, during a collection phase, the order matching system 110 receives order packets corresponding to orders. For example, the order matching system 110 can receive an order signal 250 (see FIGS. 2A-2E) from the order transmission device 120. The order packets can form a stream of order packets and the signal extractor 206 can extract the order packets from the stream of order packets and/or information about the order packets (e.g., a type of order, a time-in-force of the order, an order side, an order identifier, a device identifier, a quantity, a price). Alternatively, the order packets can be received as packets and the signal extractor 206 can extract information about the order packets. The order packets can include buy orders corresponding to a request to purchase a financial instrument and sell orders, corresponding to a request to sell a financial instrument.

Referring briefly to FIGS. 5A and 5B, shown therein are example order packets 500A, 500B. As shown in FIG. 5A, the order packet can include fields including metadata, an order identifier, a user identifier, a payload, an order type, an order side, an order time-in-force (“TIF”) and a state though it will be understood that the order packet can include other fields. As shown in FIG. 5B, in some embodiments, the order request packet additionally includes a timestamp. The timestamp field can be an editable field that can be modified by the processor 112 of the order matching system 110, which can edit the timestamp field to write the time at which the order packet is received by the order matching system 110. The user identifier field can identify a user associated with the order packet (e.g., dealer identifier) and/or a trader identifier. A dealer or trader identifier can be used by the order matching system 110 to determine a type of user. For example, some user identifiers may be associated with retail client orders while others may be associated with institutional client orders. In some embodiments, the user identifier field can include a transmitting device identifier of the device transmitting the order packet. The order identifier field can include identifying information for the order packet. Alternatively, or in addition thereto, the order identifier can be an editable field that can be edited by the order matching system 110 to associate a sequence number or identifier indicative of the order of reception of the order request packet.

The content of the payload can vary, depending on the type of order but can include order details including pricing information and quantity information. The order type field can include information about the type of order. In some embodiments, the order type field includes a type of order management or execution strategy (e.g., midpoint peg, limit order, market peg, primary peg).

The order TIF field includes information about whether the order is time-limited and if so, the time limitation (e.g., expires at the end of a matching phase, expires at the end of the day, good until cancelled). For example, an order can have a “DAY” order TIF, which expires at the end of a trading day or an “Event-or-Cancel (“EOC”)” order TIF, which expires at the end of the first matching phase after the collection phase during which the order is received. In some other examples, the order can be a “Good-Till-Date (“GTD”)” order, which expires until a specified date and/or time, or a “Good-Till-Cancelled(“GTC”)” order, which expires until it is explicitly cancelled or fulfilled.

The order side field can indicate whether the order is a buy order or a sell order.

The state field can be an editable field that can indicate whether the order is executable or non-executable. The order matching system 110 can initialize the state field of the order packets received at 310, by, for example, setting the state field of order packets received at 310 to non-executable when the order packets are received.

In some embodiments, the order matching system 110 can generate a record for each order packet that includes information about the order packet and transmit the generated records for display via a market data feed when the order matching system 110 receives order packets. For example, the order matching system 110 can assign a display price to each order packet based on pricing information included in the order packet. In some embodiments, a record is only generated for orders that are not time-limited to a matching phase.

At 320, during the collection phase, the order matching system 110 stores the order packets in memory. For example, the order matching system 110 can store the order packets in the data store 208.

As shown in FIG. 2A, the order packets 220 can be stored in a single data store 208. As explained, the data store 208 can include a buffer that stores the order packets 220. As shown in FIG. 2B, alternatively, the order packets 220 can be stored in a data store 208 that includes a first buffer 210a and a second buffer 210b. For example, order packets corresponding to a first order type can be stored in a first buffer 210a and order packets corresponding to a second order type can be stored in a second buffer 210b. For example, order packets can be stored according to their time limitation. As another example, order packets corresponding to buy orders can be stored in the first buffer 210a and order packets corresponding to sell orders can be stored in the second buffer 210b.

Alternatively, as shown in FIG. 2D, the order packets 220 can be stored in different data stores 208 according to, for example, their order type. Further, the order packets 220 can be stored in a greater number of data stores 208.

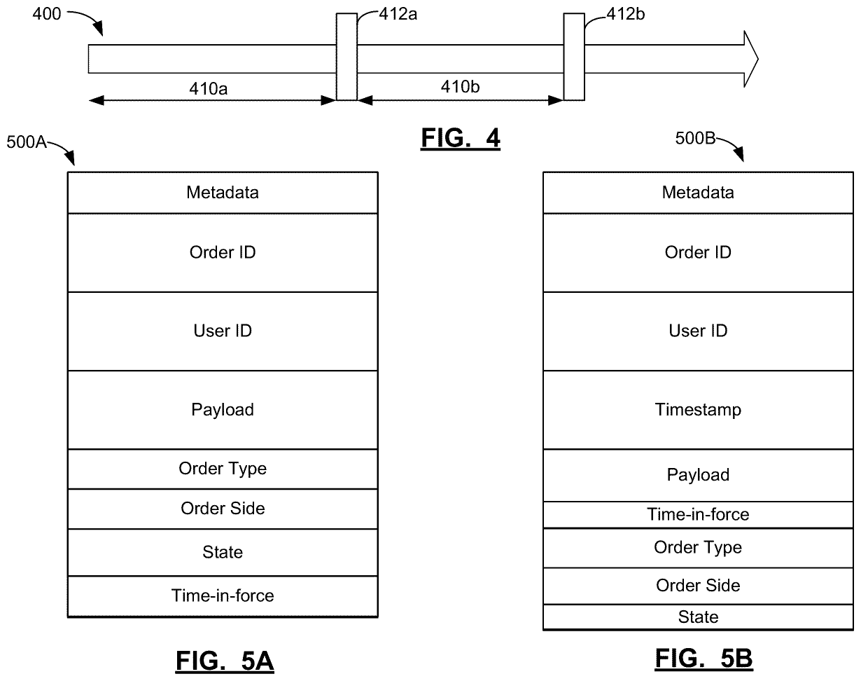

As shown in FIG. 4, which shows a timeline 400 of an order matching process, the order matching system 110 receives order packets and stores the order packets during the collection phase 410a.

In some embodiments, during the order collection phase 410, the order matching system 110 can receive a request to modify an order associated with an order packet. For example, the order matching system 110 can receive an order modification packet. As explained, the order matching system 110 can allow orders to be modified since orders are only matched during matching phases 412. The order modification packet can include an indication to cancel the order (e.g., an order cancellation packet) or to amend the payload of the order. For example, the price and/or quantity of the order can be modified. In some embodiments, the payload of the order packet is an editable field and the payload can be amended upon receipt of an order modification packet. Alternatively, the order packet can be edited to include a reference to the order modification packet so that when the order matching system 110 commences the processing of the order associated with the order packet, the order matching system 110 can retrieve information from the order modification packet. In some embodiments, when an order is modified, the timestamp or order identifier (e.g., sequence number) associated with the order can be modified to the timestamp at which the order is modified. Order modification packets may be received from the transmission device 120 and/or generated by the order matching system 110 when a change in market conditions causes a trading price of an order to change.

When the order modification packet is an order cancellation packet, the order packet can be removed from the data storage 208. Alternatively, the order packet can be amended to include an indication to not execute the order associated with the order packet during the order matching phase 412.

The order matching system 110 can modify the record associated with the order packet and the market data feed can be updated.

At 330, during a matching phase, the order matching system 110 retrieves the order packets from memory. For example, the order matching system 110 can retrieve the order packets from the data store 208. The order packets retrieved can be queued for execution. In some embodiments where order packets 220 are stored in a single data store 208, the order matching system 110 can retrieve the orders and categorize the orders prior to execution. In some embodiments, the order matching system 110 can retrieve the order packets from memory as the orders are executed, as explained at step 340.

In some embodiments, upon retrieving the order packets from memory, the order matching system 110 modifies the state field of the order packets from a non-executable state to an executable state. In some embodiments, the state is only modified if one or more predetermined conditions are met, for example, if a predetermined price condition is met. For example, for an order of type “midpoint peg”, the state of the order packet may only be changed to “executable” if the limit price of the order packet is greater than or equal to the protected national best bid and offer (PBBO) midpoint for the particular financial instrument. In some embodiments, the order matching system 110 modifies the state field of the order packets in the order in which they are received so that orders that are received first (i.e., associated with an earlier time stamp or lower sequence number) can be matched before orders that are received later. In other embodiments, the order matching system 110 modifies the state field of all order packets eligible for fulfillment (e.g., all orders meeting predetermined conditions) to an executable state.

In some embodiments, the order matching system 110 transitions orders to an executable state by identifying all orders eligible to be matched and transferring the orders to a separate component, for example, a data store. Alternatively, the order matching system 110 can maintain a list of executable orders and upon identification that an order is eligible to be matched, update the list.

As shown in FIG. 4, which shows a timeline 400 of an order matching process, the order matching system 110 retrieves the order packets from memory at time 412a.

At 340, in response to determining that at least a subset of the buy orders and the sell orders are compatible (i.e., can be matched), the order matching system 110 matches at least a subset of the buy orders and the sell orders of the same financial instrument according to one or more order matching characteristics of the buy orders and the sell orders. Each order can be matched with multiple other orders. For example, an order can be matched with one or more orders until the order is filled. The order matching system 110 can identify an order to be matched and parse the executable contra-side orders (e.g., a list of orders) to identify orders with which to match the order.

In some embodiments, the matching is performed sequentially, that is, the order matching system 110 attempts to match one order at a time until the order is filled. The order matching system 110 can execute step 340 for each type of financial instrument. The order matching system 110 can match orders associated with order packets having an executable state. The order matching process can be performed by the matching component 212 shown in FIGS. 2A-2E. The order matching characteristics according to which the order matching system 110 matches the buy orders and the sell orders can include but are not limited to a dealer identifier, an order of reception of the order, a price of the order, a quantity of the order, and a priority type of the order. In some embodiments, the priority type of the order can indicate an order of priority of the characteristics. For example, the priority type of an order packet can indicate that the matching is to be prioritized based on the order of reception of the order packets.

In at least some embodiments, the matching is based on an order of reception of the order packets such that the order matching system 110 prioritizes matching of earlier received order packets. As described, in some embodiments, each order packet includes a timestamp field that can indicate a timestamp at which the order packet is received by the order matching system 110. In such embodiments, the order matching system 110 can determine the order of reception based on the timestamps of each order packet.

As described, in some embodiments, the order packets may not include a timestamp. In such embodiments, the order matching system 110 can store the order packets in the order they are received and retrieve the order packets in the order received. Alternatively, the order matching system 110 can assign a sequence number to each order packet received. In some embodiments, as shown in FIG. 2C, the order packets can be transmitted from a first data store 208 to a second data store 216 that can store the order packets in the order they are received.

In some embodiments, the order matching system 110 prioritizes matching orders associated with the same dealer identifier or other information included in the user identifier. For example, the priority type of the order matching system 110 can indicate that the order matching system 110 is to prioritize matching orders originating from the same dealer.

In some embodiments, the order matching system 110 matches orders according to a type of the order and/or an order TIF. In some embodiments, the order matching system 110 matches orders of a first type and/or TIF before proceeding to matching orders of a second type or TIF, as will be explained in further detail below. As described, the order TIF can indicate the time limitation associated with the order and the order type can indicate the type of execution strategy. The order matching system 110 can match orders associated with a first type of execution strategy before matching orders associated with a second type of execution strategy. For example, orders having an order type “midpoint peg” can be matched by the order matching system 110 prior to all other types of order types. Similarly, the order matching system 110 can match orders associated with a first type of time limitation before matching orders associated with a second type of time limitation. In some embodiments, the order matching system 110 includes a dedicated matching component 212 for each type of execution strategy (e.g., a matching component for orders of type “midpoint peg” and a matching component for other execution strategies).

In some embodiments, as will be explained in further detail below, the order matching system 110 can implement separate matching protocols according to the order type and/or TIF. For example, as shown in FIG. 2D, the order packets 220 can be stored in different data stores 208a, 208b according to the order type of the order packets 220 and the matching component 212 can process the order packets 220 in each data store 208 separately. Alternatively, the order matching system 110 can include separate matching components 212 for each type of order and/or order TIF, which can be implemented by the same or by separate processors. For example, the order matching system 110 can include a matching component for matching orders tradeable in a midpoint book and a matching component for matching orders tradeable in a visible book so that orders having different execution strategies are not matched together.

In some embodiments, the order matching system 110 generates a trade report summarizing the orders matched at 340. The trade report can be published on a market data feed.

Referring back to FIG. 4, order matching system 110 retrieves the order packets from memory and matches the orders during matching phase 412a.

As shown in FIG. 4, the collection phase 410 and matching phase 412 are non-overlapping phases and order packets received during the collection phase 410 are only matched during the matching phase 412. The duration of the collection phase 410 can be randomized and have a minimum and maximum duration that are based on factors including a time of the day, a type of financial instrument, a listing exchange and/or a previous session's closing price. In some embodiments, each of the factors is associated with a minimum duration and a maximum duration and the order matching system 110 can determine the minimum duration and maximum duration of the collection phase 410 based on the factors selected. For example, each of the factors can be enabled or disabled by an administrator of the order matching system 110. When a factor is enabled, the corresponding minimum and maximum associated with the factor can take priority. For example, if the financial instrument type “ETF” is enabled, the minimum duration of the collection phase 410 can be 5000 μs and the maximum duration can be 10,000 μs.

The duration of the collection phase 410 can be on the order of milliseconds and can have a randomized or fixed duration. The duration of the matching phase 412 can be determined by the time taken to match orders that can be matched. For example, the matching phase 412 can be only long enough to allow the orders that can be matched to be matched. The start of each matching phase 412 can be determined based on the established duration of the collection phase, which can be scheduled at microsecond precision, where each microsecond between the minimum and maximum time is equally likely to be the microsecond scheduled for the end of the collection phase 410 (and therefore the start of the matching phase 412). For example, if it is desired that the beginning of a matching phase occurs at a minimum of 2,850 μs and maximum of 3,150 μs from the end of the last matching phase, the collection period duration may be set with a 150 μs window around a fixed time of 3 ms.

In this example, if the last matching phase 412a ended and accordingly the collection phase 410b began at 10:30:05.005252, the subsequent matching phase 412b may begin at some random point in time between 10:30:05.008102 and 10:30:05.008252 (i.e., last matching phase 412+2,850 μs being the lower end and last matching phase 412+3,150 μs being the upper end.) In some embodiments, the maximum duration of the collection phase 410 is 6 ms-10 ms.

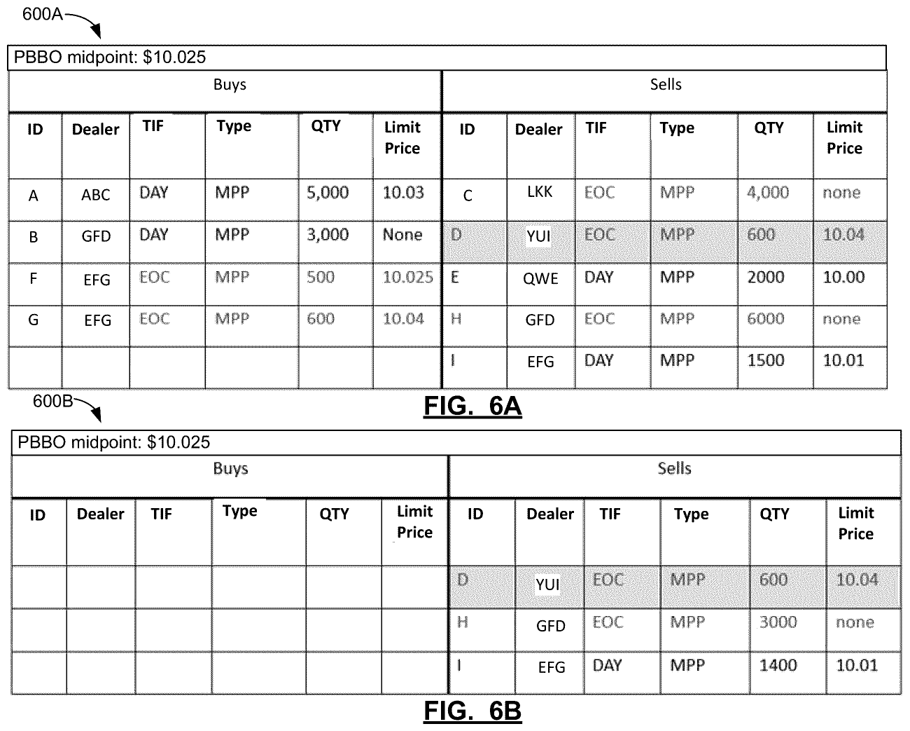

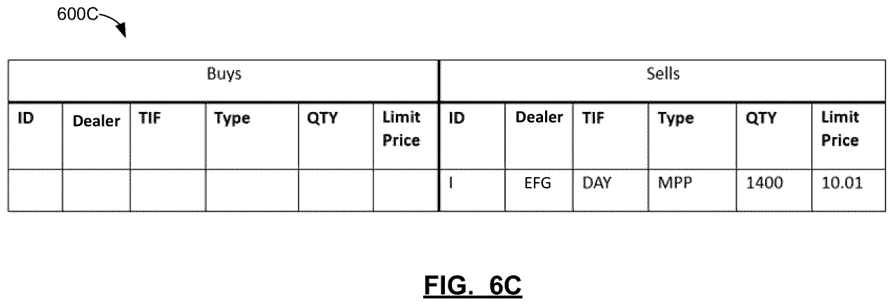

Reference is now made to FIGS. 6A-6C, which show an example matching process. In the example matching process illustrated in FIGS. 6A-6C, the matching is based on the order of reception and the dealer identifier. FIG. 6A shows a table 600A of orders A to I received during a collection phase. In the example of FIG. 6A, the orders A to I are orders of the type midpoint peg orders that can be executed at the midpoint of the PBBO.

In the example shown in FIG. 6A, orders A, B, E and I are orders of a first TIF and orders F, G, C, D and H are orders of a different TIF. In the example shown, orders A, B, E and I correspond to an order TIF “DAY” (i.e., orders that expire at the end of the trading day if they are not executed) and orders F, G, C, D and H correspond to an order TIF “Event-or-Cancel” (EOC) corresponding to orders that are cancelled if they cannot be matched by the end of the matching phase. The order identifiers A to I can correspond to the order in which the orders A to I were received during the order collection phase 410. In the example shown in FIG. 6A, the midpoint price is $10.025. Since the limit price of order D is less aggressive than the midpoint, order D may not be filled. Accordingly, the order matching system 110 may not transition order D to an executable state.

In the example of FIGS. 6A-6C, all executable orders are transitioned to an executable state at the start of the matching phase 412 and each executable order is processed according to its order of reception. EOC orders expire at the end of the matching phase and therefore can only be matched during one matching phase. During the matching process, order A is transitioned first to an executable state based on its order of reception. For example, the order matching system 110 can edit the state field of the order packets to an executable state. 4000 shares of order A are matched with 4000 shares of order C and the remaining 1000 shares of order A are matched with order E. Order B is then transitioned to an executable state and the 3000 shares of order B are matched with 3000 shares of order H since orders B and H originate from the same dealer (i.e., are associated with the same dealer identifier GFD). Order E is then transitioned to an executable state (since order C has been fulfilled and order D is not executable); 500 shares of order E are matched against 500 shares of order F, and the remaining 500 shares of order E are matched against 500 shares of order G. Order G is then transitioned to an executable state, and the remaining 100 shares of order G are matched against 100 shares of order I. In some embodiments, the order matching system 110 can prioritize matching orders of TIF EOC over orders of TIF DAY, or vice versa.

As shown in table 600B of FIG. 6B, the orders remaining include 600 shares of order D, which was not made executable by the order matching system 110, 3000 shares of order H and 1400 shares of order I.

In some cases, users may wish to avoid trading non-displayed volume against orders that do not meet a certain volume threshold. In some embodiments, the order matching system 110 identifies orders to match according to a minimum interaction size (MIS). The minimum interaction size can correspond to a minimum order quantity of a contra-side order (a sell or buy order). The minimum interaction size can be specified by the order transmission device 120 transmitting an order packet. For example, the order packet can include a MIS instruction. The MIS threshold size can be the lesser of the specified MIS size and an order's remaining quantity. For example, if an order is associated with a MIS of 500 shares but only has 200 shares remaining, the MIS threshold size can be 200 shares. The order matching system 110 can determine the MIS threshold size based on the specified MIS size and the order's remaining quantity.

Where present on an order of type midpoint peg order, the MIS size can establish the size threshold for a contra-side order to be eligible to trade against it (based on the order quantity of the contra-side order). If the threshold is not met, the order matching system 110 may not match the order.

In cases where two orders of type midpoint peg orders include an MIS, the order matching system 110 may only match the orders if both sides' MIS size requirements are met. If only one side is satisfied, the order matching system 110 may not match the orders and each of the two orders may be matched against other orders that satisfy the particular order's MIS.

As explained, the order matching system 110 can generate a report of orders. In some cases, the user may not wish to disclose the full quantity of their order. In such cases, the order matching system 110 may generate a report disclosing only a portion of the total size of the order (iceberg order). This can allow users to transmit large orders without disclosing the total size of the order.

In such cases, the size of the display portion can be set by the user, for example, the order packet can include a direction to display only a portion of the volume of the order. In some embodiments, the direction can be executed only for some order types, or for certain combinations of order types and/or TIFs, for example, orders of TIF DAY and type primary peg (“DAY primary peg”) and orders of TIF DAY and type limit (“DAY limit”). The non-displayed portion may be available for fulfillment. In some embodiments, the non-displayed portion is only fulfilled after the displayed portion is fulfilled.

In some embodiments, a MIS instruction can be applied to the non-display portion. A MIS instruction, when applied to a non-display portion, can introduce efficiencies into the order matching system 110. In the context of periodic matching such as the order matching system 110, non-display portions may obtain multiple potential counterparties including one or more potentially undesirable or predatory, information-seeking counterparties. Additionally, in the order matching system 110, counterparties who offer a size of one board lot may have the opportunity to interact with the non-display portion of an order, which is not possible in continuous matching systems when interacting against the non-display portion of an order that has both a displayed and non-displayed portion. By preventing interactions with one or more counterparties that are offering insufficient volume to satisfy the MIS condition, the number of messages exchanged within the order matching system 110 can be reduced, reducing resource requirements when compared to systems that do not allow for an MIS to be applied to a non-display portion. In addition, counterparties can be prevented from obtaining information relating to the non-display portion of an order when offering insufficient volume to satisfy the MIS instruction, which can enhance information security for the user.

In at least one embodiment, a MIS instruction can be applied to the non-display portion of a DAY primary peg order. In a periodic matching system such as the order matching system 110, primary peg orders can emulate the common practice among sophisticated users on speedbump systems to cancel and reprice orders during periods where the likelihood of receiving an undesirable execution is high. The periodic matching nature of the order matching system 110, by delaying all orders, can reduce message traffic, and reduce resource requirements when compared to speedbump systems for the order matching system 110 and for such users or other users that may instead rely on primary peg orders, by automatically repricing orders with a primary peg instruction at times when the PBBO price becomes less aggressive, which often coincides with moments where there is a high likelihood of receiving an undesirable execution. In some embodiments, the order matching system 110 includes a combination of displayed and non-displayed portions, a primary peg instruction, and a MIS condition.

In some embodiments, some orders that remain partially or wholly unfilled after the matching phase 412 can be returned to memory. For example, orders that are not time-limited or do not expire at the end of the matching phase 412 can be returned to memory while orders that are time-limited or limited to a collection phase can be cancelled upon conclusion of the matching phase 412. The order packets 220 corresponding to unmatched orders to be retained can be retained in the data store 208 or can be re-stored in the data store 208, depending on the implementation of the order matching system 110. For example, in embodiments where the order packets are extracted from the data store 208 at the start of the matching phase 412, the order packets can be returned to the data store 208. The unmatched order packets can then be retrieved for matching during a subsequent matching phase 412. Since the unmatched order packets can have a lower sequence number and/or an earlier timestamp than order packets received during a subsequent collection phase 410 (if they have not been modified), the unmatched orders associated with the order packets can be prioritized for matching during the subsequent matching phase 412.

In some embodiments, the order matching system 110 can receive an order modification packet to modify an order packet that remains partially or wholly unfilled. For example, it may be desirous to amend the price of an order that was not wholly filled during the previous matching phase 412. In such cases, the order matching system 110 can amend the order, as explained above and in some cases, edit the timestamp or the sequence number (e.g., the sequence number in the order identifier) of the order packet.

In the example of FIGS. 6A-6C, as shown in FIG. 6C, since orders D and H are orders of TIF EOC (i.e., orders that expire at the end of the matching phase) and remain unfilled at the end of the matching phase, the unfilled portions of orders D and H are cancelled. Since order I is an order of TIF DAY, order I can be returned to memory and can be matched during a subsequent matching phase 412.

In some embodiments, the matching phase includes two stages, enabling at least some orders to have multiple opportunities to be matched, thereby allowing more orders to be filled and allowing orders that would otherwise be cancelled when unfilled to be filled. Reference is now made to FIGS. 7A-7B, which show another example matching process. In the example matching process illustrated in FIGS. 7A-7B, the matching is based on the order of reception, the price, and the dealer identifier (e.g., a dealer identifier comprised in the user identifier field), so that better priced orders have priority over worse priced orders, visible portions of day orders have priority over non-visible portions, the matching of orders associated with the same dealer identifier is prioritized, and so that earlier received orders are executed before later received orders. FIG. 7A shows table 700a of orders A to M received during a collection phase. The sequence number associated with each of the orders indicates an order of reception of the orders.

In this example, orders A, B, C, H, J, K, M are orders of TIF DAY and orders D, E, F, G, I, L are orders of TIF EOC. In this example, the matching process occurs in two stages. During the first stage, EOC orders are matched against DAY orders and the trade pricing is determined by the executable price of the DAY order. During the second stage, unfilled EOC orders with a limit price that is equal to or better than the PBBO midpoint are matched against each other at the midpoint price, instead of being cancelled. That is, in some embodiments, the order matching system 110 matches orders of a first TIF with orders of a second TIF prior to matching orders of the first TIF, together. By using a two-stage matching process, the order matching system 110 can allow for more opportunities for two orders to be matched when compared to continuous matching systems, which attempt to trade time-limited orders upon receipt and speedbump systems, which only allow one opportunity for time-limited orders to be matched. In addition, by matching EOC orders with a limit price that is equal to or better than the PBBO midpoint, the order matching system 110 can match orders at improved prices.

In the example of FIGS. 7A-7B, orders of TIF type DAY are already in an executable state at the start of the matching phase 412 and orders of TIF EOC are transitioned to an executable state during the matching phase 412, in the order in which they are received. In the example of FIGS. 7A-7B, the protected national best bid (PBB) is $10.00 and the protected national best offer (PBO) is $10.05 resulting in a PBBO midpoint of $10.025.

In this example order D is transitioned to an executable state first, since as explained, EOC orders are transitioned to an executable state according to their sequence number and order D is the EOC order associated with the lowest sequence number (i.e., 4). Order D can trade down to $10.00. Orders A and C (TIF DAY) have the best tradeable price of $10.05. Since order A is associated with a sequence number of 15 and order C is associated with a sequence number of 3 and orders A and C are not associated with the same dealer identifier as order D, the order matching system 110 can prioritize matching order C over order A and the order matching system 110 can match 800 shares of order D with the 800 shares of order C. The remaining 200 shares of order D can be matched with 200 shares of order A. Since order D is now completely filled, the order matching system 110 can transition a subsequent order of type EOC to an executable state.

Order E is then transitioned to an executable state since order E is the order of TIF EOC associated with the lowest sequence number (i.e., 5). Order E has a limit price of $9.99 and can accordingly be matched with order A at order A's tradeable price since order A has the highest tradeable price. The order matching system 110 can match 800 shares of order E against the remaining 800 shares of order A. The remaining 1000 shares of order E can be matched with the 700 shares of order K at the tradeable price of order K ($10.00). Order K can be prioritized over order J since order E and K are associated with the same dealer identifier “WGF”. Order E then has 300 shares remaining, which can be matched against 300 shares of order J.

The order matching system 110 can then transition order F of TIF EOC associated with the lowest sequence number (i.e., 6) to an executable state. The order matching system 110 matches the 300 shares of order F against 300 shares of order B at the tradeable price of order B ($10.03). Order F is now filled.

The order matching system 110 can then transition order G to an executable state since order G is the order of TIF EOC associated with the next lowest sequence number (i.e., 7) and matches 200 shares of order G with the remaining 200 shares of order B at its tradeable price of $10.03. Since order G has 400 remaining shares, the order matching system 110 can match 200 shares of order G with 200 shares of order H at the tradeable price of order H ($10.04) and 100 of the 200 remaining shares of order G with 100 shares of order M at the tradeable price of order M ($10.04). Order I can then be transitioned to an executable state, as the EOC order associated with the next lowest sequence number (i.e., 11). However, since the limit price of order I is $10.02 and the tradeable price of order J, the only remaining order of TIF DAY, is $10.00, order I is not executed since the limit price is not met. Order L can then be transitioned to an executable state. However, since there are no remaining sell DAY orders, order L is not executed. As shown in table 700b in FIG. 7B, at the conclusion of the first stage, orders G, J, L and I remain partially or wholly unfilled.

During the second stage, as explained, orders of TIF EOC are matched against remaining EOC orders. By matching remaining EOC orders with other EOC orders, a greater number of orders can be matched during the matching phase. Since order G is the EOC order associated with the lowest sequence number (i.e., 7), the order matching system 110 matches the remaining 100 shares of order G at the PBBO midpoint of $10.025 against 100 shares of order I. As described, a dual stage matching process can allow the order matching system 110 to match a greater number of orders, allowing more orders to be filled and allowing orders that would otherwise be cancelled when unfilled to be filled. Further, by allowing orders that would otherwise be cancelled when unfilled to be filled, the order matching system 110 can receive fewer new orders corresponding to unfilled orders, reducing the number of exchanges between the order matching system 110 and the order transmission device 120.

The order matching system 110 then matches 400 shares of order I (i.e., the EOC order having the next lowest sequence number) with 400 shares of order L (also an EOC order) at the PBBO midpoint since order L has a limit price that is equal to or better than the PBBO midpoint and order J is of type DAY and is not eligible for matching during this second stage since only EOC orders are eligible to be matched during the second stage. As exemplified by FIGS. 7A-7B, the order matching system 110 can process each order individually to identify a match for the order, and in the order of receipt of the order.

In some cases, users with retail orders may wish to advertise active order flow to solicit counterpart liquidity, encourage price improvement. In some embodiments, the order matching system 110 generates a retail signal for such orders originating from users or associated with user identifiers associated with retail orders. By generating a retail signal, the visibility of retail orders can be enhanced, increasing the likelihood that the orders will be filled by generating additional orders to be submitted in an attempt to trade with the signaled retail orders. The order matching system can generate a retail signal for each order received when conditions for generating the retail signal are met. For example, the conditions can include: the order type field of the order packet identifies the order as either a limit order or market peg order of TIF EOC, the user identifier associated with retail orders, as identified in a retail ID table, and the tradeable price of the order is equal to or more aggressive than the PBBO midpoint.

In some cases, generating a retail signal can lead to intermediation of passive DAY liquidity through “broker preferencing”, wherein orders can be matched with other orders originating from the same dealer before similarly priced orders from other dealers.

To address this issue, in some embodiments, the order matching system 110 assigns a priority tier to each order and matches the orders based on their priority tier. For example, the order matching system 110 can edit the order packet to add a priority tier to the order. The order matching system 110 can assign a “committed” priority tier to each order on the opposite side of the first order of TIF EOC that triggers a retail signal during a particular collection phase 410 that have timestamps that predate that first order and can assign a “responsive” priority tier to any order of TIF DAY on the opposite side of that order that arrives during that collection phase 410 following the generation of the retail signal.

Orders of TIF DAY that originate from a previous collection phase 410 can be assigned a “committed” priority tier for the current matching phase 412. The designation of “responsive” can apply to orders of TIF DAY received on the opposite side of a retail signal. For example, if a retail signal indicating a buying retail order of TIF EOC is generated, sell DAY orders received after the signal for the remainder of the collection phase 410 can be marked as responsive.

The order matching system 110 can prioritize orders marked as committed over orders at the same price marked as responsive. In such embodiments, the order matching system 110 prioritizes matching in the following order: price, visibility, priority tier, dealer identifier and time, where visibility corresponds to the visible portion of an order. As explained in some embodiments, some orders can have a visible portion and a hidden portion.

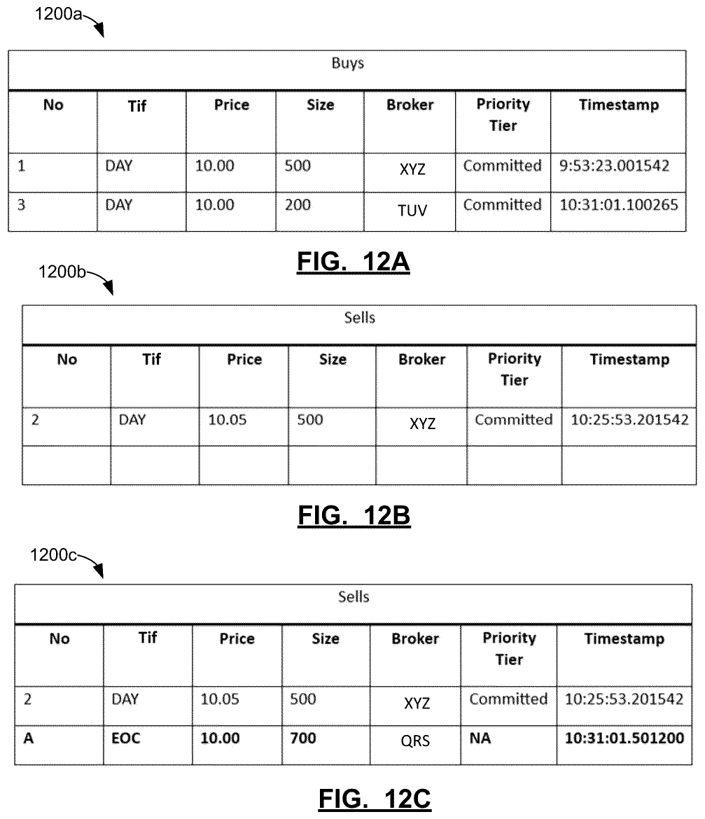

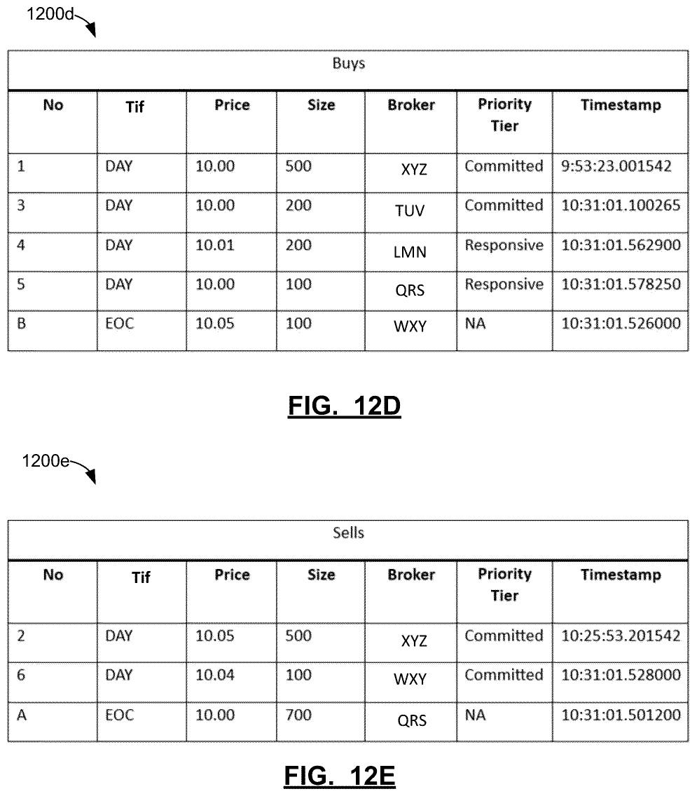

Referring now to FIGS. 12A-12E, shown therein are tables 1200a-1200e showing an example matching process by the order matching system 110. At time t₁ 10:31:01.500100 shown in FIGS. 12A, 12B corresponding to the start of a collection phase 410 orders 1 to 3 are stored in the data store 208, and correspond to orders that returned to memory due to being partially or wholly unfilled at the end of the last matching phase 412. As shown, since orders 1-3 originate from a previous collection phase 410, the orders are assigned a priority tier of “committed”. At time t₂ shown in FIG. 12C order A is received. As shown, order A is an order to sell of TIF EOC received at timestamp 10:31:01.501200 and a retail signal can be generated. As explained, any order of TIF DAY on the opposite side of that contra-side order (in this case, any buy order) of TIF DAY that arrives during that collection phase 410 following order A is assigned a priority tier of “responsive”.

FIGS. 12D, 12E show the list of orders received during the collection phase 410, immediately prior to the matching phase 412. As shown, orders received subsequent to order A on the opposite side of order A are assigned a “responsive” priority tier. In the example shown, order 6 is on the same side as order A and cannot be responsive to order A, and accordingly order 6 is assigned a “committed” priority tier. In the example of FIG. 12D, order B is not a retail order and accordingly does not trigger the generation of a retail signal and would not affect the priority tier of other buy orders, such as order 6 shown in FIG. 12E received subsequent to order B, but marked as “committed” because order B is not a retail order.

During the matching phase, order A is transitioned to an executable state first, since orders of TIF EOC are matched first and order A is the EOC order associated with the earliest timestamp. The order matching system 110 executes it with order 4 first (at a price of $10.01), since in the example shown, order 4 as a TIF DAY has price priority over all over DAY orders on the same side (all priced at $10.00). 200 shares of order A are matched with the 200 shares of order 4. The order matching system 110 then matches the remaining 500 shares of order A with 500 shares of order 1, since, in the example shown, order 1 has a committed priority tier and has the earlier timestamp of committed priority tier order requests on the same side. The order matching system 110 then matches 100 shares of order B with 100 shares of order 6. Orders 2 and 6 have a priority tier of “committed”, but order 6 has priority as it is associated with the same dealer identifier as order B.

The method 300 can be repeated. For example, the order matching system 110 can receive subsequent order packets during a second collection period 410b and the orders can be matched during a second matching phase 412b. During the matching phase 412, the order matching system 110 may match orders received during the collection phase 410, as well as orders of type DAY carried over from a previous matching phase, and order packets received during the matching phase 412a can be held in memory until the next collection phase 410b and the next matching phase 412b if the order is not cancelled before the next matching phase 412b. For example, as shown in FIG. 2E, order packets 220 received during a matching phase 412 can be stored in a secondary data store 208c. When the matching phase 412 concludes and a subsequent collection phase 410 begins, the order packets 220 stored in the data store 208c can be transmitted to the primary data store 208a along with order packets 220 received during the subsequent collection phase 410.

As discussed above, the order matching system 110 can generate a record for each order and the record can include a display price for the order. A DAY limit order, for example, can be assigned a display price that is the least aggressive of the stated limit price and the PBBO midpoint price. A DAY primary peg order, as another example, can be assigned a display price that is the least aggressive of the stated limit price, the indicated peg price and the PBBO midpoint. To avoid two contra-side orders being displayed at the same PBBO midpoint, the order matching system 110 can apply an offset to orders of TIF DAY orders that cross the PBBO midpoint so that the orders are displayed at a price that is at or inside the PBBO midpoint. The offset can be for example, half of a standard price increment inside the PBBO midpoint where the PBBO midpoint is a half trading increment (e.g., a half cent for orders priced at/over $0.50 and a quarter cent for orders priced under $0.50), at the PBBO midpoint where the PBBO midpoint is a full trading increment and a contra-side order is not currently displayed at the PBBO midpoint, or one full trading increment (e.g., 1 cent) inside the PBBO midpoint if a contra-side order is already displayed at the PBBO midpoint.

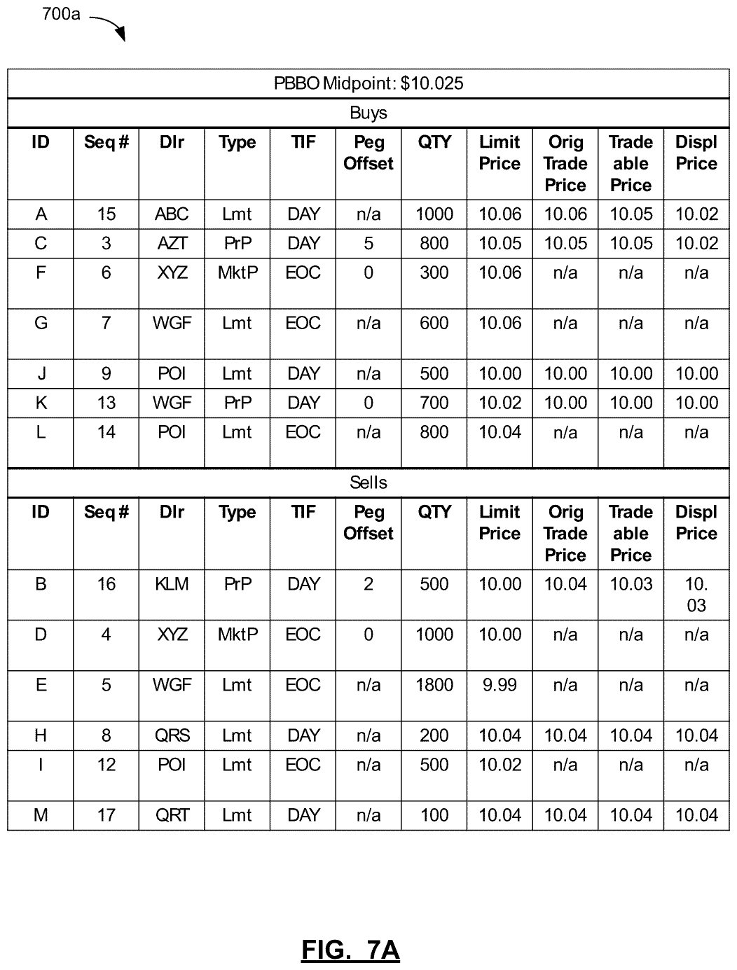

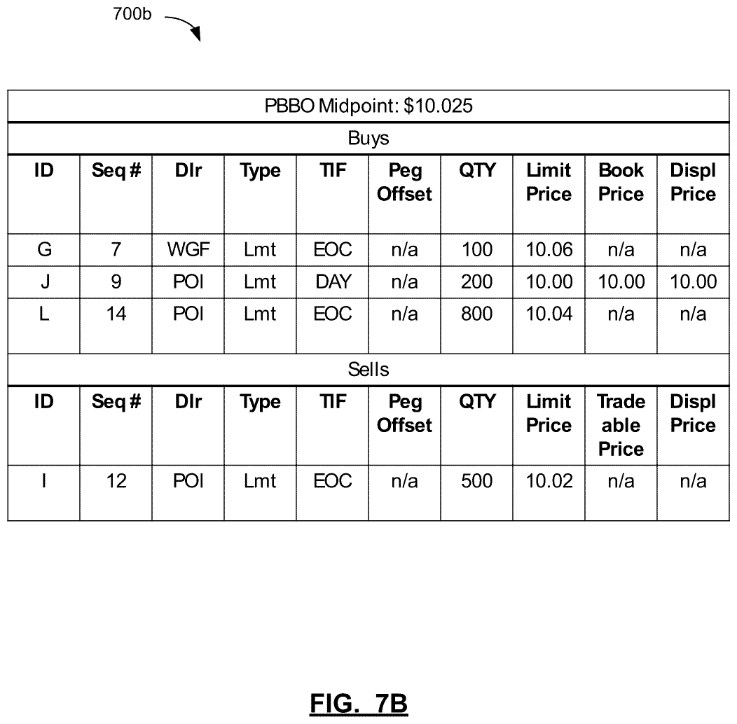

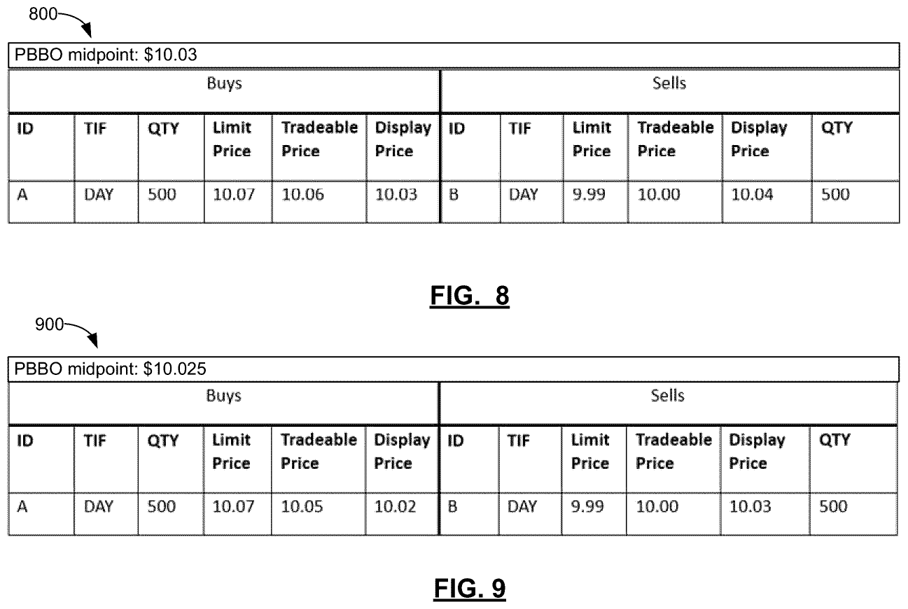

Referring briefly to FIG. 8, which shows a table 800 showing example DAY limit orders A and B, the PBBO midpoint is $10.03 (based on a PBB of $10.00 and a PBO of $10.06). Since order A is received earlier than order B, and the PBBO midpoint is a full trading increment, order A is assigned a display price of the PBBO midpoint $10.03 and order B is assigned a price that is one standard price increment within the PBBO midpoint (i.e., $10.04).

Referring briefly to FIG. 9, which shows a table 900 showing example DAY limit orders A and B, the PBBO is $10.025 (based on a PBB of $10.00 and a PBO of $10.05). Since order A is received earlier than order B, and the PBBO midpoint is a half trading increment, order A is assigned a display price that is a valid price increment for display (i.e., displayed at $10.02) inside of the PBBO midpoint of $10.025 which is not a valid price increment for display, and order B is assigned a display price that is similarly a valid price increment for display inside of the PBBO midpoint (i.e. displayed at $10.03).

In some cases, changes in the PBB, PBO or the PBBO midpoint may necessitate a change in the display price and/or the tradeable price of an order of TIF DAY. In such cases, the order matching system 110 can change the display price and/or tradeable price of the sell and/or buy orders. The order in which the order matching system 110 can change the display price and/or tradeable price can vary, depending on whether a change has occurred in the PBO or the PBB, causing the PBBO midpoint to change. For example, if the PBBO midpoint increases (i.e., if the PBB or PBO price increase, or if both the PBB and the PBO change simultaneously causing the PBBO midpoint to increase), the order matching system 110 can update the sell DAY orders before updating the buy DAY orders. When updating the sell orders, the order matching system 110 can also leave the display price of a sell order unchanged if its display price prior to the PBBO midpoint change is the same as the updated PBBO midpoint. By updating sell orders first in response to an increase in the PBBO midpoint and leaving the display price of sell orders unchanged if their display price prior to the PBBO midpoint change is the same as the updated PBBO midpoint, the number of order message updates transmitted by the order matching system 110 and received by the order reception device 130 is minimized, reducing the demand on processing resources for both the order matching system 110 and its users. Updating the sell orders first and leaving the display price of sell orders unchanged if their display price prior to the PBBO midpoint change is the same as the updated PBBO midpoint can also prevent the temporal locking or crossing of the best displayed bid and best displayed offer (i.e., a best displayed bid that is equal to or higher than the best displayed offer) that might otherwise occur if the display prices of buy orders were updated first to prices that were the same or higher than the best displayed offer, reducing processing complexity

As another example, if the PBBO midpoint decreases (i.e., if the PBB or PBO decreases to a lower price), the order matching system 110 can update the buy DAY orders first, before updating the sell DAY orders, similarly reducing the number of order message updates transmitted between the order matching system 110 and the order reception device 130, and avoiding the temporal locking of the best displayed bid and best displayed offer.

If a PBBO update is received but there is no change to the PBBO midpoint (e.g., both the PBB and the PBO have changed and the PBBO spread is widening or narrowing around the midpoint by the same amount on each side), the order matching system 110 can update either of the buy DAY orders or the sell DAY orders first. Where the display and/or tradeable price of more than one order is to be changed, the order matching system 110 can update the prices according to the sequence numbers or timestamp associated with each of the orders.

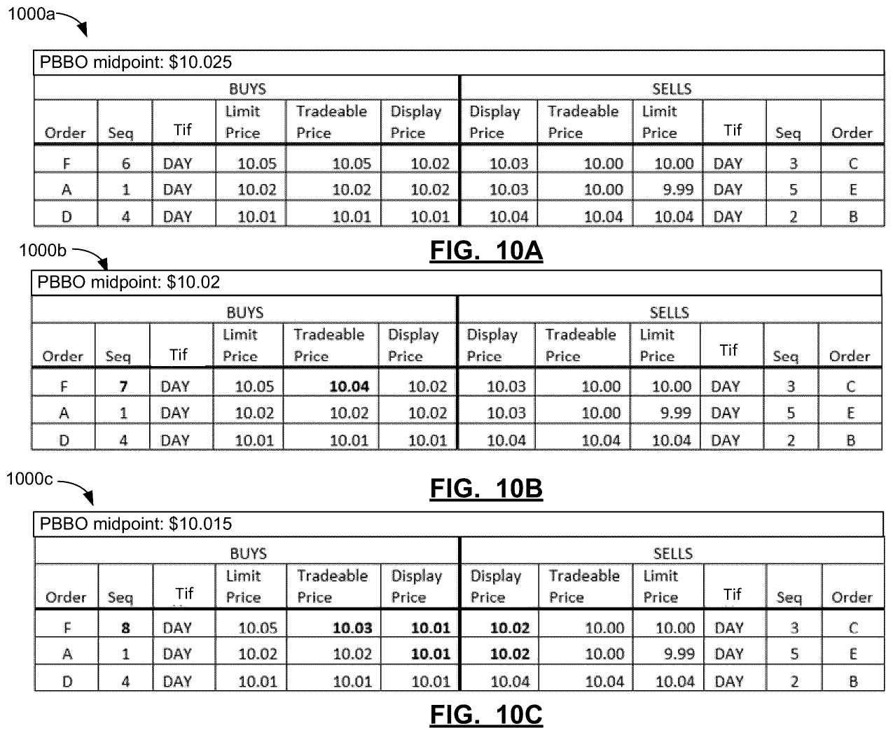

Reference is now made to FIGS. 10A-10D, which show tables 1000a-1000d showing a series of updates to the display price. Orders A to F are DAY limit orders. The sequence number associated with each of the orders indicates an order of reception of the orders. At time t₀, illustrated in table 1000a, the PBBO midpoint is $10.025, based on a PBB of $10.00 and a PBO of $10.05.

As shown, order A has a tradeable price and a display price that is inside the current PBBO midpoint of $10.025 (since $10.02 is the first valid trading increment for display lower than the midpoint of $10.025). Order B has a limit price of $10.04, that is less aggressive than both the opposite side PBBO (i.e., the PBB) and the PBBO midpoint and so its display and tradeable price at entry equals its limit $10.04. Sell order C has a limit price of $10.00 which is equal to the opposite side PBBO (i.e., the PBB), and so it is assigned a tradeable price of $10.00. As the PBBO midpoint is an invalid trading increment for display (a half cent), the order matching system 110 modifies the display price of order C to $10.03 (inside the midpoint). Buy order D has a limit price of $10.01 that is less aggressive than both the opposite side PBBO (i.e., PBO) and the PBBO midpoint, and so its display and tradeable price at entry are set to the limit price of $10.01. Sell order E has a limit price of $9.99, which is more aggressive than the opposite side PBBO (i.e., PBB), and so the order matching system 110 constrains its tradeable price at the PBB of $10.00. As the PBBO midpoint is an invalid trading increment for display, the order matching system 110 assigns the order E a display price of $10.03 so that it is displayed at a price inside the PBBO midpoint. Buy order F has a limit price of $10.05 which is equal to the opposite side PBBO (i.e., the PBO), and so it is assigned a tradeable price of $10.05. Because it is priced through the PBBO midpoint, the order matching system 110 constrains its display price to $10.02, which is inside the PBBO midpoint.

At time t₁, associated with table 1000b of FIG. 10B, the PBO is updated to $10.04, causing the PBBO to decrease to $10.02 (the midpoint of a PBB of $10.00 and a PBO of $10.04). The order matching system 110 can update the display price and/or tradeable price of orders A to F to reflect the PBBO change. The order matching system 110 can update the prices according to the order of reception of the orders and update the buy orders first. Since orders A and D have a limit price that remains inside the opposite-side PBBO, no change to their tradeable price is needed and since order A and D have a display price that is at or inside the updated PBBO, the order matching system 110 makes no change to their display prices.

The display price of order F remains unchanged as it is equal to the PBBO midpoint of $10.02. Since the tradeable price is now constrained by the PBO, the tradeable price of order F is modified by the order matching system 110 to $10.04. Since the tradeable price is modified, the order packet associated with order F is amended to modify the new sequence number and/or timestamp. As explained, in some cases, the order matching system 110 can generate modifications to an order packet.

The order matching system 110 then proceeds to update the tradeable and/or display prices of the sell orders. Since the display price of all of the sell orders is within the PBBO midpoint of $10.02 (i.e., the display price is equal to or higher than the PBBO) and there are already buy orders of TIF DAY displayed at the PBBO midpoint of $10.02, no updates are needed to the display price. Since the tradeable price of sell orders is not affected by the PBO change, the order matching system 110 does not update any of the sell orders tradeable prices.

At t₂, associated with table 1000c of FIG. 10C, the PBO is updated to $10.03, causing the PBBO midpoint to decrease to $10.015 (the midpoint of a PBB of $10.00 and a PBO of $10.03). The order matching system 110 can update the display price and/or tradeable price of orders A to F to reflect the PBBO change. The order matching system 110 can update the buy orders first. Since order A has a limit price that is inside the PBO, its tradeable price remains unchanged. However, since its display price is through the PBBO midpoint of $10.015 (i.e., it is higher than the PBBO midpoint), the order matching system 110 updates the display price to $10.01.

Since the limit price and tradeable price of order D are less aggressive than the PBO and the display price of 10.01 is not constrained by the PBBO midpoint, no updates are required to the tradeable price or display price of order D.

The tradeable price of order F is changed, as it is constrained by the PBO of $10.03. Because its tradeable price has changed (from $10.04 to $10.03) order F receives a new sequence number and/or timestamp. The display price of order F is changed since it is through the PBBO midpoint (since 10.02 is higher than the PBBO midpoint of 10.015).

The order matching system 110 then proceeds to updating the sell orders. Since the limit price and tradeable price of order B are not affected by the PBO change to $10.03 and the display price remains within the PBBO midpoint of $10.015 (i.e., the display price is equal to or less aggressive than the PBBO midpoint), no updates are needed to order B.

The tradeable price of sell order C remains unchanged as its limit and tradeable price continue to be at but not through the PBB. Its tradeable price is through the PBBO midpoint and the PBBO midpoint of $10.015 is an invalid price increment for display, and so its display price is updated to $10.02 which is inside the PBBO midpoint of $10.015.

Similar to order C, only the display price of sell order E updates to $10.02 due to its aggressive limit and tradeable price.

At t₃, associated with table 1000d of FIG. 10D, the PBB is updated to $10.01, causing the PBBO midpoint to increase to $10.02 (the midpoint of a PBB of $10.01 and a PBO of $10.03). The order matching system 110 can update the display price and/or tradeable price of order A to F to reflect the PBBO change. The order matching system 110 can update the sell orders first, since the change to the PBBO is caused by an increase to the PBB.

Since order B has a limit price that is at or inside the PBB, its tradeable price remains unchanged. Since order B has a display price that is at or inside the PBBO midpoint, its display price remains unchanged.

The tradeable price of order C updates to $10.01 as its tradeable price is now constrained by the PBB and the order matching system 110 assigns a new sequence number to order C. The display price of order C remains unchanged since its display price is already at the PBBO midpoint of $10.02, and order C is the first order to be repriced.

The tradeable price of Order E updates to $10.01 as it is constrained by the PBB and the order matching system 110 assigns a new sequence number to order E. The display price of order E remains unchanged since its display price is already at the PBBO midpoint.

The order matching system 110 then proceeds to updating the buy orders. Since the current tradeable price of order A was already constrained to the PBO of $10.03 and the PBO did not change, its tradeable price remains unchanged. Its display price remains unchanged at $10.01 since the display price is within the PBBO midpoint and there are already sell orders displayed at the PBBO midpoint.

Similar to order A, no changes are needed to order D since the current tradeable price of order D is not violating the tradeable price constraints and the display price was already within the PBBO midpoint.

Similar to orders A and D, the tradeable price of order F was already constrained to the PBO of $10.03 and the PBO did not change. No change to the display price is required because it was already within the PBBO midpoint.

In some cases, during the collection phase 410, the PBBO may be locked (i.e., the PBB is equal to the PBO) or crossed (i.e., the PBB is higher than the PBO) and accordingly, there may be no valid PBBO midpoint that can act as a display price constraint. In such cases, display prices can correspond to, for DAY limit orders, the least aggressive of the stated limit price, the PBBO midpoint, or, if the PBBO is locked or crossed, one full increment less aggressive than the opposite side PBB/PBO and for DAY primary peg orders, the least aggressive of the stated limit price, the indicated peg price, the PBBO midpoint, or if the PBBO midpoint is locked or crossed (i.e., the PBB is higher than the PBO), one full increment less aggressive than the opposite side PBB/PBO.

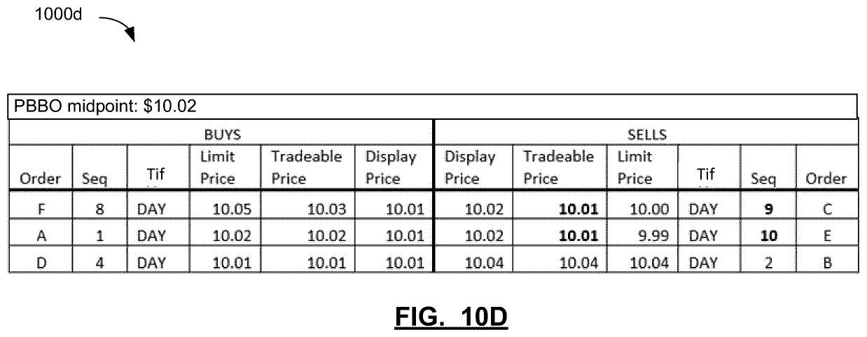

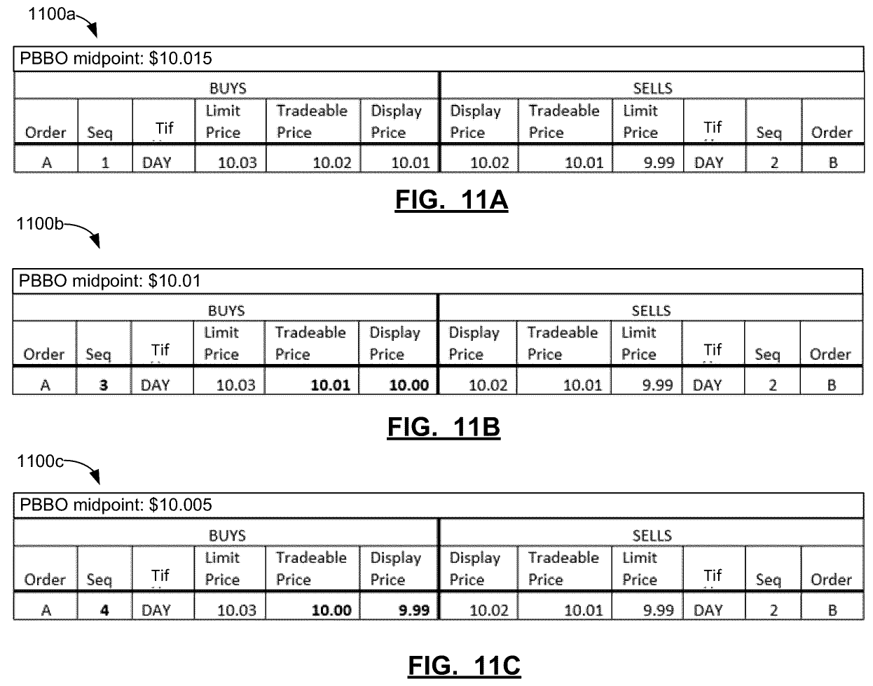

Reference is now made to FIG. 11A, which shows table 1100a, showing example display prices and tradeable prices for orders A and B at time t₁. In the example of FIG. 11A, the PBBO midpoint is $10.015 (based on a PBB of $10.01 and PBO of $10.02). Orders A and B are orders of the TIF DAY. The tradeable price of order A is constrained by the opposite side PBO of $10.02 and the display price of order A is constrained by the PBBO midpoint of $10.015. The order matching system 110 accordingly sets the display price of order A to $10.01, which is inside the PBBO midpoint. The tradeable price of order B is constrained by the opposite side PBB of $10.01 and the display price of order B is constrained by the PBBO midpoint of $10.015. The order matching system 110 accordingly sets the display price of order A to $10.02, which is inside the PBBO midpoint.

Reference is now made to FIG. 11B, which shows table 1100b, showing example display prices and tradeable prices for orders A and B at t₂ when the PBBO is locked. For example, during the collection phase 410, the PBO changes to $10.01. The PBBO is accordingly now locked since the PBO and the PBB are both $10.01, causing an invalid PBBO midpoint of $10.01. Since the PBBO midpoint decreased (from $10.015 to $10.010), buy orders of TIF DAY are updated first. Since the PBBO is locked, the order matching system 110 updates the display price of order A to one full increment less aggressive than the opposite side PBO to $10.00 ($0.01 less than $10.01). The tradeable price of order A is also updated to 10.01 as it is constrained by the opposite side PBO ($10.01). The order matching system 110 additionally edits the order packet to update the sequence number of order A, since the tradeable price of order A has been changed.

The tradeable price of order B is constrained by the opposite side PBB of $10.01. Since the tradeable price of order B is already $10.01, the tradeable price of order B remains unchanged. The display price of order B remains unchanged as it is already displayed one full increment less aggressive than the opposite side PBB ($0.01 more than $10.01), being the display that would apply in this case as the PBBO is locked at $10.01.

Reference is now made to FIG. 11C, which shows table 1100c, showing example display prices and tradeable prices for orders A and B at t₃ when the PBBO changes again. In the example of FIG. 11C, the PBO changes to $10.00, resulting in a crossed PBBO (a PBB of $10.01 and a PBO of $10.00) and an invalid PBBO midpoint of $10.005. Since the PBBO midpoint decreased (from $10.010 to $10.005), buy orders of TIF DAY are updated first. The display price of order A is constrained by the updated PBO of $10.00 since the PBBO is crossed, and so the order matching system 110 updates the display price to one full increment less aggressive than the opposite side PBO to $9.99 ($0.01 less than $10.00). The tradeable price of order A is also updated to $10.00 as it is constrained by the opposite side PBO ($10.00). The order matching system 110 additionally edits the order packet to update the sequence number of order A, since the tradeable price of order A has been changed.

The tradeable price of order B is constrained by the opposite side PBB of $10.01. Since the tradeable price of order B is already $10.01, the tradeable price of order B remains unchanged. Since the display price of order B of $10.02 is still one full increment less aggressive than the opposite-side PBB ($10.01), the display price of order B remains unchanged.

In some cases, when an order of the TIF DAY is received, one or both of the PBBO sides (PBB and PBO) may be missing. In such cases, the display price assigned by the order matching system 110 may be the least aggressive of: the opposite side PBB/PBO minus one standard increment, the opposite side best displayed bid/offer on the trading venue minus one standard increment, the indicated peg price in the case of a primary peg (assuming the same-side PBB/PBO exists and it is the opposite side that is missing) and the limit price of the order.

In some cases, some types of orders can include a peg offset value. In such cases, the order packet can include a peg offset value, specifying a relative distance from the reference point PBB or PBO at which to set the tradeable price of the order. The relative distance from the PBBO can be expressed in standard price increments in a separate peg offset tag that can form part of the payload of the order packet, where positive numbers are more aggressive than the same-side PBBO (higher for buy and lower for sell), a value of 0 maintains a price that is equal to the same side PBBO, and a negative number is less aggressive than the same side PBBO. Peg offset can have a default value of 0. The indicated peg price for an order of type primary peg or of type market peg at any given time can therefore be determined taking into consideration the applicable reference PBB/PBO and the peg offset value (applicable reference value for a primary peg is the same side PBB/PBO and the opposite side for a market peg). For example, for a PBBO consisting of a PBB $10.00 and PBO $10.05, a buy order of type primary peg with a peg offset of 1 can have an indicated peg price of $10.01 (PBB+$0.01). As another example, a buy order of type market peg with a peg offset of negative 1 can have an indicated peg price of $10.04 (PBO-0.1).

An order of type primary peg can be assigned a tradeable price and display price upon receipt during a collection phase 410 when the order matching system 110 generates the records for the orders. The tradeable price can be assigned based on the stated limit price, the indicated peg price, or the opposite-side PBBO. For example, the tradeable price can be the least aggressive price of the stated limit price, the indicated peg price and the opposite-side PBBO. The display price can be assigned based on the stated limit price, the indicated peg price, the PBBO midpoint and if the PBBO midpoint is locked or crossed, one full increment less aggressive than the opposite-side PBBO. The display price selected can be the least aggressive of the prices listed.

In cases where an order of type primary peg is received at a time when there is no valid same-side PBBO or if a valid same-side PBBO disappears over the course of the collection phase 410, the order will be held in a non-executable state. For example, the order matching system 110 may edit the state field of the order packet if the order packet is transitioned to an executable state during the matching phase 412 or may edit the state field of the order packet to include an indication not to transition the state of the order packet during the matching phase 412. The order may remain in a non-executable state until a valid same side PBBO returns, or until the order is cancelled.

Numerous specific details are set forth herein in order to provide a thorough understanding of the exemplary embodiments described herein. However, it will be understood by those of ordinary skill in the art that these embodiments may be practiced without these specific details. In other instances, well-known methods, procedures and components have not been described in detail so as not to obscure the description of the embodiments. Furthermore, this description is not to be considered as limiting the scope of these embodiments in any way, but rather as merely describing the implementation of these various embodiments.

### Clauses

Clause 1: A method of matching orders from a plurality of order transmission devices having different network resources, the method comprising:
during an order collection phase:
   receiving from the plurality of order transmission devices over one or more networks, a plurality of order packets corresponding to orders, the plurality of order packets comprising buy order packets corresponding to buy orders and sell order packets corresponding to sell orders;
   extracting, from each of the plurality of order packets, one or more matching characteristics of the order; and
   storing the plurality of order packets in a memory; and during a matching phase subsequent to and separate from the order collection phase:
   retrieving the plurality of order packets from the memory and in response to determining at least a subset of the buy orders and the sell orders are compatible, matching at least the subset of the buy orders and the sell orders according to the one or more characteristics of the buy orders and sell orders.

Clause 2: The method of any of the preceding clauses, wherein the order collection phase has a duration of less than ten milliseconds.

Clause 3: The method of any of the preceding clauses, wherein the order collection phase has a duration of less than 100 milliseconds.

Clause 4: The method of any of the preceding clauses, comprising:
during the order collection phase, initializing a state parameter of each of the order packets; and
during the matching phase, modifying the state parameter of at least a subset of the order packets to an executable state, and
wherein the at least subset of the buy orders and the sell orders correspond to the at least subset of the order packets having the executable state.

Clause 5: The method of any of the preceding clauses, wherein each order packet comprises an order type and wherein the matching is based at least in part on the order type.

Clause 6: The method of any of the preceding clauses, wherein each order packet comprises a time limitation and wherein the matching is based at least in part on the time limitation.

Clause 7: The method of any of the preceding clauses, wherein the time limitation comprises one of: a first time limitation corresponding to orders expiring at an end of the matching phase and a second time limitation corresponding to orders expiring at an end of a trading day or a subsequent trading day, wherein the matching phase includes a first stage and a second stage occurring immediately after the first stage, and wherein, the method comprises:
during the first stage, matching orders having the first time limitation with orders having the second time limitation; and
during the second stage, matching orders unmatched during the first stage and having the first time limitation with each other.

Clause 8: The method of any of the preceding clauses, wherein the order matching characteristics comprise one or more: a dealer identifier, an order of reception of the order, a price of the order, a quantity of the order, and a priority type of the order.

Clause 9: The method of any of the preceding clauses, further comprising:
subsequent to the matching phase, storing the order packets corresponding to unmatched buy orders and sell orders expiring at an end of a trading day in the memory; and
during a future matching phase, retrieving the stored order packets from the memory.

Clause 10: The method of any of the preceding clauses, further comprising:
processing the plurality of order packets to determine an order of reception of the plurality of order packets and wherein the matching is based in part on the order of reception.

Clause 11: The method of any of the preceding clauses, wherein the order of reception is determined based on at least one of a sequence number and a timestamp associated with each order packet.

Clause 12: The method of any of the preceding clauses, further comprising:
during the order collection phase, receiving an order modification packet, the order modification packet comprising an order identifier of a buy order packet or sell order packet; and
modifying the identified buy order packet or sell order packet.

Clause 13: The method of any of the preceding clauses, wherein the order modification packet is an order cancellation packet cancelling the buy order of the identified buy order packet or the sell order of the identified sell order packet.

Clause 14: The method of any of the preceding clauses, further comprising:
in response to receiving an order packet or an order modification packet during the matching phase, storing the received order packet or the order modification packet in a second memory.

Clause 15: The method of any of the preceding clauses, wherein matching at least the subset of the buy orders and the sell orders comprises:
retrieving the order corresponding to the earliest received order packet;
identifying one or more candidate matches for the order according to the characteristics;
matching the order with one or more of the one or more candidate matches.

Clause 16: The method of any of the preceding clauses, wherein a subset of the plurality of order packets correspond to primary peg orders with a non-display portion that includes a minimum interaction size instruction, and wherein the method comprises matching at least the subset of the buy orders and the sell orders according to the minimum interaction size instruction.

Clause 17: A system for matching orders from a plurality of order transmission devices having different network resources, the system comprising at least one processor configured to:
during an order collection phase:
   receive from the plurality of order transmission devices over one or more networks, a plurality of order packets corresponding to orders, the plurality of order packets comprising buy order packets corresponding to buy orders and sell order packets corresponding to sell orders;
   extract, from each of the plurality of order packets, one or more matching characteristics of the order; and
   store the plurality of order packets in a memory; and
during a matching phase subsequent to and separate from the order collection phase:
   retrieve the plurality of order packets from the memory and in response to determining at least a subset of the buy orders and the sell orders are compatible, match at least the subset of the buy orders and the sell orders according to the one or more characteristics of the buy orders and sell orders.

Clause 18: The system of any of the preceding clauses, wherein the order collection phase has a duration of less than ten milliseconds.

Clause 19: The system of any of the preceding clauses, wherein the order collection phase has a duration in an order of milliseconds.

Clause 20: The system of any of the preceding clauses, wherein the at least one processor is configured to:
during the order collection phase, initialize a state parameter of each of the order packets; and
during the matching phase, modify the state parameter of at least a subset of the order packets to an executable state, and
wherein the at least subset of the buy orders and the sell orders correspond to the at least subset of the order packets having the executable state.

Clause 21: The system of any of the preceding clauses, wherein each order packet comprises an order type and wherein the at least one processor is configured to match at least the subset of the buy orders and the sell orders based at least in part on the order type.

Clause 22: The system of any of the preceding clauses, wherein each order packet comprises a time limitation and wherein the at least one processor is configured to match at least the subset of the buy orders and the sell orders based at least in part on the time limitation.

Clause 23: The system of any of the preceding clauses, wherein the time limitation comprises one of: a first time limitation corresponding to orders expiring at an end of the matching phase and a second time limitation corresponding to orders expiring at an end of a trading day or a subsequent trading day, wherein the matching phase includes a first stage and a second stage occurring immediately after the first stage, and wherein the least one processor is configured to:
during the first stage, match orders having the first time limitation with orders of having the second time limitation; and
during the second stage, match orders unmatched during the first stage and having the first time limitation with each other.

Clause 24: The system of any of the preceding clauses, wherein the order matching characteristics include one or more: a dealer identifier, an order of reception of the order, a price of the order, a quantity of the order, and a priority type of the order.

Clause 25: The system of any of the preceding clauses, wherein the at least one processor is configured to:
subsequent to the matching phase, store the order packets corresponding to unmatched buy orders and sell orders expiring at an end of a trading day in the memory; and
during a future matching phase, retrieve the stored order packets from the memory.

Clause 26: The system of any of the preceding clauses, wherein the at least one processor is configured to:
process the plurality of order packets to determine an order of reception of the plurality of order packets and wherein the matching is based in part on the order of reception.

Clause 27: The system of any of the preceding clauses, wherein the order of reception is determined based on one of a sequence number and a timestamp associated with each order packet.

Clause 28: the system of any of the preceding clauses, wherein the at least one processor is configured to:
during the order collection phase, receive an order modification packet, the order modification packet comprising an order identifier of a buy order packet or sell order packet; and
modify the identified buy order packet or sell order packet.

Clause 29: The system of any of the preceding clauses, wherein the order modification packet is an order cancellation packet cancelling the buy order of the identified buy order packet or the sell order of the identified sell order packet.

Clause 30: The system of any of the preceding clauses, wherein the at least one processor is configured to:
in response to receiving an order packet or an order modification packet during the matching phase, store the received order packet or the order modification packet in a second memory.

Clause 31. The system of any of the preceding clauses, wherein the at least one processor is configured to:
retrieve the order corresponding to the earliest received order packet;
identify one or more candidate matches for the order according to the characteristics;
match the order with one or more of the one or more candidate matches.

Clause 32: A method of reducing network resources during order matching, wherein a plurality of orders are received from a plurality of order transmission devices having different network resources, the method comprising:
during an order collection phase:
   receiving from a plurality of order transmission devices over a network, a plurality of order packets corresponding to orders, the plurality of order packets comprising buy order packets corresponding to buy orders and sell order packets corresponding to sell orders, a subset of the plurality of order packets corresponding to minimum interaction size non-display orders, the minimum interaction size non-display orders corresponding to orders with a non-display portion that includes a minimum interaction size instruction;
   extracting, from each of the plurality of order packets, one or more matching characteristics of the order; and
   storing the plurality of order packets in a memory; and during a matching phase subsequent to and separate from the order collection phase:
   retrieving the plurality of order packets from the memory;
   in response to determining at least a subset of the buy orders and the sell orders are compatible, the subset comprising at least one minimum interaction size non-display order,
      for the at least one minimum interaction size non-display order, matching the at least one minimum interaction size non-display order with one or more buy orders or one or more sell orders according to the one or more matching characteristics of the corresponding order packets and the minimum interaction size instruction.

Clause 33: The method of any of the preceding clauses, wherein each order packet comprises an order type and wherein the order type of each order packet corresponding to the minimum interaction size non-display orders is primary peg.

Clause 34: A system for reducing network resources during order matching, wherein a plurality of orders are received from a plurality of order transmission devices having different network resources, the system comprising at least one processor configured to:
during an order collection phase:
   receive from the plurality of order transmission devices over a network, a plurality of order packets corresponding to orders, the plurality of order packets comprising buy order packets corresponding to buy orders and sell order packets corresponding to sell orders, a subset of the plurality of order packets corresponding to minimum interaction size non-display orders, the minimum interaction size non-display orders corresponding to orders with a non-display portion that includes a minimum interaction size instruction;
   extract, from each of the plurality of order packets, one or more matching characteristics of the order; and
   store the plurality of order packets in a memory; and
during a matching phase subsequent to and separate from the order collection phase:
   retrieve the plurality of order packets from the memory;
   in response to determining at least a subset of the buy orders and the sell orders are compatible, the subset comprising at least one minimum interaction size non-display order,
      for the at least one at least one minimum interaction size non-display order, match the at least one minimum interaction size non-display order with one or more buy orders or one or more sell orders according to the one or more matching characteristics of the corresponding order packets and the minimum interaction size instruction.

Clause 35: The system of any of the preceding clauses, wherein each order packet comprises an order type and wherein the order type of each order packet corresponding to the minimum interaction size non-display orders is primary peg.

Clause 36: A method of reducing network resources during order matching, wherein a plurality of orders are received from a plurality of order transmission devices having different network resources, the method comprising:
receiving, from an order transmission device, an order packet corresponding to an order;
determining, at a processor, based on one or more order matching characteristic, whether the order is a retail order;
in response to determining that the order is a retail order, generating, by the processor, a retail signal associated with the retail order to increase visibility of the retail order;
assigning, by the processor, to each contra-side order, received during a collection phase following generation of the retail signal, a priority tier designation, wherein:
   contra-side orders received prior to the retail signal are assigned a committed priority tier, and
   contra-side orders received subsequent to the retail signal are assigned a responsive priority tier; and
during a matching phase, matching by the processor, the retail order with at least one contra-side order according to a priority hierarchy attribute.

Clause 37: The method of any of the preceding clauses, wherein the priority hierarchy attribute is selected based on an attribute list comprising one or more of price, visibility, priority tier, dealer identifier, and time.

Clause 38: The method of any of the preceding clauses, wherein determining whether the order is a retail order comprises determining whether the order is one or more of: a limit order, a market peg order with a event-or-cancel (EOC) order type, an order with a price attribute equal to or greater than a prevailing midpoint of a protected best bid and offer (PBBO) or an order corresponding to a target retail identifier.

Clause 39: A computer-implemented method for dynamically determining and updating a display price for an electronic trading order in an electronic system for matching electronic trading orders, the electronic trading orders being received from a plurality of order transmission devices having different network resources system, the method comprising:
receiving, by a server comprising at least one processor and a memory, order data defining a trading order, the order data comprising one or more of an order type, a side, and a limit price;
obtaining, from one or more external servers, current values of a protected best bid (PBB) and a protected best offer (PBO);
determining, by the processor, a reference midpoint price based on the PBB and the PBO;
determining, by the processor, a display price for the trading order based on one or more of the limit price of the trading order and the reference midpoint price;
dynamically updating, by the processor, the display price of the trading order in real-time in response to a change in the PBB, the PBO or the reference midpoint price; and
causing the display price to be transmitted to a display interface of the trading system for publication to market participants.

Clause 40: The method of any of the preceding clauses, wherein dynamically updating the display price of the trading order comprises updating the display price when the trading order is a sell order and when the reference midpoint price increases.

Clause 41: The method of any of the preceding clauses, wherein dynamically updating the display price of the trading order comprises updating the display price when the trading order is a buy order and when the reference midpoint price decreases.

Clause 42: The method of any of the preceding clauses, wherein dynamically updating the display price comprises adjusting the display price by a predetermined offset increment from the reference midpoint price when the PBB and PBO are locked or crossed.

Clause 43: The method of any of the preceding clauses, wherein the display price of the trading order is constrained within a range defined by the PBB and the PBO.

1. A method of matching orders from a plurality of order transmission devices having different network resources, the method comprising:
during an order collection phase:
receiving from the plurality of order transmission devices over one or more networks, a plurality of order packets corresponding to orders, the plurality of order packets comprising buy order packets corresponding to buy orders and sell order packets corresponding to sell orders;
extracting, from each of the plurality of order packets, one or more matching characteristics of the order; and
storing the plurality of order packets in a memory; and
during a matching phase subsequent to and separate from the order collection phase:
retrieving the plurality of order packets from the memory and in response to determining at least a subset of the buy orders and the sell orders are compatible, matching at least the subset of the buy orders and the sell orders according to the one or more characteristics of the buy orders and sell orders.
The method of claim 1, wherein the order collection phase has a duration of less than 100 milliseconds.
The method of claim 1, comprising:
during the order collection phase, initializing a state parameter of each of the order packets; and
during the matching phase, modifying the state parameter of at least a subset of the order packets to an executable state, and
wherein the at least subset of the buy orders and the sell orders correspond to the at least subset of the order packets having the executable state.
The method of claim 1, wherein each order packet comprises an order type and/or a time limitation and wherein the matching is based at least in part on the order type and/or the time limitation.
The method of claim 4, wherein the time limitation is one of: a first time limitation corresponding to orders expiring at an end of the matching phase and a second time limitation corresponding to orders expiring at an end of a trading day or a subsequent trading day, wherein the matching phase includes a first stage and a second stage occurring immediately after the first stage, and wherein, the method comprises:
during the first stage, matching orders having the first time limitation with orders having the second time limitation; and
during the second stage, matching orders unmatched during the first stage and having the first time limitation with each other.
The method of claim 1, wherein the order matching characteristics include one or more: a dealer identifier, an order of reception of the order, a price of the order, a quantity of the order, and a priority type of the order.
The method of claim 1, further comprising:
subsequent to the matching phase, storing the order packets corresponding to unmatched buy orders and sell orders expiring at an end of a trading day in the memory.
The method of claim 1, comprising:
processing the plurality of order packets to determine an order of reception of the plurality of order packets and wherein the matching is based in part on the order of reception.
The method of claim 8, wherein the order of reception is determined based on one of a sequence number and a timestamp associated with each order packet.
The method of claim 1, further comprising:
during the order collection phase, receiving an order modification packet, the order modification packet comprising an order identifier of a buy order packet or sell order packet; and
modifying the identified buy order packet or sell order packet.
The method of claim 10, wherein the order modification packet is an order cancellation packet cancelling the buy order of the identified buy order packet or the sell order of the identified sell order packet.
The method of claim 1, further comprising:
in response to receiving an order packet or an order modification packet during the matching phase, storing the received order packet or the order modification packet in a second memory.
The method of claim 1, wherein matching at least the subset of the buy orders and the sell orders comprises:
retrieving the order corresponding to the earliest received order packet;
identifying one or more candidate matches for the order according to the characteristics;
matching the order with one or more of the one or more candidate matches.
The method of claim 1, wherein a subset of the plurality of order packets correspond to primary peg orders with a non-display portion that includes a minimum interaction size instruction, and wherein the method comprises matching at least the subset of the buy orders and the sell orders according to the minimum interaction size instruction.
A system for matching orders from a plurality of order transmission devices having different network resources, the system comprising at least one processor configured to:
during an order collection phase:
receive from the plurality of order transmission devices over one or more networks, a plurality of order packets corresponding to orders, the plurality of order packets comprising buy order packets corresponding to buy orders and sell order packets corresponding to sell orders;
extract, from each of the plurality of order packets, one or more matching characteristics of the order; and
store the plurality of order packets in a memory; and
during a matching phase subsequent to and separate from the order collection phase:
retrieve the plurality of order packets from the memory and in response to determining at least a subset of the buy orders and the sell orders are compatible, match at least the subset of the buy orders and the sell orders according to the one or more characteristics of the buy orders and sell orders.
The system of claim 15, wherein the order collection phase has a duration of less than 100 milliseconds.

17. The system of claim 15, wherein the at least one processor is configured to:
during the order collection phase, initialize a state parameter of each of the order packets; and
during the matching phase, modify the state parameter of at least a subset of the order packets to an executable state, and
wherein the at least subset of the buy orders and the sell orders correspond to the at least subset of the order packets having the executable state.

18. The system of claims 15, wherein each order packet comprises an order type and/or a time limitation and wherein the matching is based at least in part on the order type and/or the time limitation.

19. The system claim 18, wherein the time limitation is one of: a first time limitation corresponding to orders expiring at an end of the matching phase and a second time limitation corresponding to orders expiring at an end of a trading day or a subsequent trading day, wherein the matching phase includes a first stage and a second stage occurring immediately after the first stage, and wherein the least one processor is configured to:
during the first stage, match orders having the first time limitation with orders of having the second time limitation; and
during the second stage, match orders unmatched during the first stage and having the first time limitation with each other.

20. A method of reducing network resources during order matching, wherein a plurality of orders are received from a plurality of order transmission devices having different network resources, the method comprising:
during an order collection phase:
receiving from a plurality of order transmission devices over a network, a plurality of order packets corresponding to orders, the plurality of order packets comprising buy order packets corresponding to buy orders and sell order packets corresponding to sell orders, a subset of the plurality of order packets corresponding to minimum interaction size non-display orders, the minimum interaction size non-display orders corresponding to orders with a non-display portion that includes a minimum interaction size instruction;
extracting, from each of the plurality of order packets, one or more matching characteristics of the order; and
storing the plurality of order packets in a memory; and
during a matching phase subsequent to and separate from the order collection phase:
retrieving the plurality of order packets from the memory;
in response to determining at least a subset of the buy orders and the sell orders are compatible, the subset comprising at least one minimum interaction size non-display order,
for the at least one minimum interaction size non-display order, matching the at least one minimum interaction size non-display order with one or more buy orders or one or more sell orders according to the one or more matching characteristics of the corresponding order packets and the minimum interaction size instruction.
